(19) United States
(12) Patent Application Publication
(10) Pub. No.: US 2017/0196253 A1
(43) Pub. Date: Jul. 13, 2017

(54) TEXTURED INGESTIBLE PRODUCTS

(71) Applicant: EETBE, INC., Memphis, TN (US)

(72) Inventor: Fernando QVYJT, Memphis, TN (US)

(21) Appl. No.: 15/321,024

(22) PCT Filed: Jun. 30, 2015
(86) PCT No.: PCT/US15/38584

§ 371 Date: Dec. 21, 2016

Related U.S. Application Data
(60) Provisional application No. 62/021,000, filed on Jul. 3, 2014.

(51) Int. Cl. A23P 10/30; A23L 13/00; G06Q 30/06; A23L 19/12

(52) U.S. Cl. CPC A23P 10/30; A23L 19/14; A23L 13/03; G06Q 30/0601; A23V 2002/00

(57) ABSTRACT

A processed ingestible plant having a coating, and a method for coating an ingestible item. The coating imparts a long lasting texture to the ingestible item. The coating mimics the exterior tissue of an edible plant, and includes parts that are derived from multiple fragments of edible plant exterior tissues.

This application claims priority to U.S. Provisional Application No. 62/021,000 filed Jul. 3, 2014, the disclosure of which is incorporated by reference in its entirety herein.

### BACKGROUND OF THE INVENTION

In the culinary arts, there is an interest to impart a certain coating on a digestible item that alters or preserves its exterior texture. For example, there is a growing interest of imparting crispy texture on digestible items such as food. Such crispiness is often accomplished through the usage of deep frying. The present invention relates to a coating which does not necessitate frying, blanching, pre-frying, and the de-oiling to impart the desired texture. The present invention allows for retention of such texture for a prolonged period of time.

### SUMMARY OF THE INVENTION

In a first aspect, the invention relates to a method for coating an ingestible item comprising: a) grinding at least a section of an edible plant tissue to form a multiplicity of ground edible plant tissue parts, wherein the size of said ground edible plant tissue parts is at least one cell of said edible plant tissue, and the size of said ground edible plant tissue parts is at most five hundred cells of said edible plant tissue; and wherein said edible plant tissue is selected from the group consisting of epidermis, periderm, sclerenchyma and phloem; a) preparing a mixture or suspension comprising a fluid and said ground edible plant tissue parts; b) coating an ingestible item with said mixture or suspension to form a final coated ingestible item; c) cooking said final coated ingestible item to form an ingestible item having a cooked coating, wherein said cooked coating imparts an external texture on said ingestible item, wherein said external texture remains essentially intact for at least eight hours after said cooking.

In some exemplary embodiments, the method further comprises homogenizing said mixture or suspension to form a homogenized mixture or suspension. In some exemplary embodiments, the mixture or suspension is a homogenized mixture or suspension. In some instances, the coating further comprises coating the ingestible item with the homogenized mixture or suspension to form an excessively coated ingestible item, and removing excess of the homogenized mixture or suspension from the excessively coated ingestible item to form a final coated ingestible item.

In some exemplary embodiments, the preparing comprises agitating. In some exemplary embodiments, the preparing comprises mixing, agitating, vortexing, whisking, forking, paddling, high-sheer mixing or stirring.

In some embodiments, the homogenized mixture or suspension has a viscosity of at least 0.01 centipoises.

In some exemplary embodiments, the plant epidermis tissue comprises cuticle tissue, upper epidermis tissue, lower epidermis tissue, palisade mesophyll, spongy mesophyll, vascular bundle, stoma complex, pavement cells, trichome cells, and conical cells. In some aspects, the plant vascular bundle comprises sheath, xylem and phloem.

In some aspects, the external texture is selected from the group consisting of hardness, crunchiness, crispiness, crumbliness, brittleness and resilience. Sometimes, the cooked coating imparts a crispy texture on said ingestible item. In some instances, the crispy texture is maintained at least one day after said cooking. Sometimes, the crispy texture imparts a peak force of at least 25 Newtons per gram. In some aspects, the crispy texture imparts a peak force of at most 45 Newtons per gram. In some embodiments, the crispy texture has a moisture content of at most 35 weight by weight percent of water as compared to the total weight of the crispy texture. In some examples, the crispy texture imparts an ultrasonic velocity of at least 200 minutes per second. Sometimes, the crispy texture imparts an ultrasonic velocity of at most 800 minutes per second. In some exemplary embodiments, the crispy texture transmission loss of at least 0.30 dB/mm. In some aspects, the crispy texture transmission loss of at most 1.30 dB/mm.

In some exemplary embodiments, the cooked coating imparts a crispy texture on the ingestible item. Sometimes, the crispy texture is maintained at least one day after the cooking. In some instances, the cooked coating imparts a desired mouth-feel upon the ingestible item.

In some embodiments, the cooked coating alters the migration of at least one of active-ingredient, nutrient, toxin. In some exemplary embodiments, the cooked coating alters at least one of oxidation or discoloration, of the ingestible item.

In some exemplary embodiments, the cooking comprises baking. Sometimes, the baking is baking in a temperature of at least 25 degrees Celsius. In some aspects, the baking is baking in a temperature of at most 350 degrees Celsius. In some exemplary embodiments, the cooking comprises frying, microwaving, freezing, boiling, sautéing, broiling or grilling. In some embodiments, the coating comprises spraying, dipping, smearing or immersing.

In some exemplary embodiments, the ingestible item comprises an edible substance selected from the group consisting of a carbohydrate, a protein, oil, and a nucleic acid. Sometimes, the ingestible item comprises a vegetable, a fruit, a meat or a pharmaceutical. In some exemplary embodiments, the vegetable is a root vegetable. In some examples, the root vegetable is a potato or sweet-potato. In some exemplary embodiments, the root vegetable is a potato.

In some exemplary embodiments, the fruit is a Musa plant. Sometimes, the Musa is a banana, plantain or combination thereof.

In some exemplary embodiments, the coating imparted on the final coated ingestible item is of at least 0.001 weight by weight percent. Sometimes, the coating imparted on the final coated ingestible item is of at least 0.5 weight by weight percent. In some embodiments, the coating imparted on the final coated ingestible item is of at least one weight by weight percent. In some instances, the coating imparted on the final coated ingestible item is of thickness of at least 0.01 micrometer. In some exemplary embodiments, the coating imparted on the final coated ingestible item is of thickness of at most 50,000 micrometer.

In some examples, the method further comprises adding a second coating on the final coated ingestible item. In some exemplary embodiments, the second coating is selected from the group consisting of the homogenized mixture or suspension, bread crumbs, panko, batter and cereal. Sometimes, the ground edible plant tissue parts comprise at least one weight by weight percent of the homogenized mixture or suspension. In some exemplary embodiments, the ground edible plant tissue parts comprise at most eighty five weight by weight percent of the homogenized mixture or suspension. Sometimes, the method does not comprise a second coating.

In some exemplary embodiments, the coating comprises covering at least 75 weight by weight percent of the ingestible item.

In some exemplary embodiments, the edible plant comprises an edible plant parts selected from the group consisting of roots, stems, leaves, flowers, fruits, bark and seeds. In some examples, the edible plant is selected from the edible plant group consisting of root vegetables, root-like vegetable stem, modified plant stems and plant bulbs. In some exemplary embodiments, the edible plant comprises potato.

In some embodiments, the edible plant is an edible cactus. Sometimes, the cactus at least one of aloe Vera or Opuntia.

In some examples, the homogenized mixture or suspension comprises particles of at least 0.001 micrometers. In some instances, the homogenized mixture or suspension comprises particles of at most 50,000 micrometers. Sometimes, the homogenized mixture or suspension viscosity is at most 10,000,000 centipoises.

In some embodiments, the mixture or suspension further comprising cellulose. Sometimes, the cellulose is selected from the group consisting of cellulose, hemicellulose, modified cellulose and modified hemicellulose. In some exemplary embodiments, the hemicellulose is selected from the group consisting of xylooligosaccharides, glucoronoxylan, arabinoxylan, glucomannan and xyloglucan. In some exemplary embodiments, the modified cellulose is selected from the group consisting of methyl cellulose, ethyl cellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose and carboxymethyl cellulose.

In some instances, the mixture or suspension further comprises a monosaccharide, a disaccharide or an oligosaccharide. Sometimes, the mixture or suspension further comprises a beneficial agent. In some examples, the mixture or suspension further comprises a binding agent. Sometimes, the binding agent comprises polysaccharides or polypeptides. In some aspects, the binding agent is selected from the group consisting of starch, pectin and gelatin. Sometimes, the starch is derived from the plant selected from the group consisting of potato, corn, rice, wheat, barley, oat, tapioca, arrow root, guar gum, locust bean, arracacha, buckwheat, kudzu, oca, sorghum, sweet potato, taro, yam, banana, cassava, sago, fava, lentil and pea. In some examples, the starch is present in flour. In some embodiments, the starch is made from the plant selected from the group consisting of potato, corn, rice, wheat, barley, oat, tapioca, arrow root, guar gum, locust bean, arracacha, buckwheat, kudzu, oca, sorghum, sweet potato, taro, yam, banana, cassava, sago, fava, lentil and pea. In some embodiments, the flour is made from the plant selected from the group consisting of potato, corn, rice, wheat, barley, oat, tapioca, arrow root, guar gum, locust bean, arracacha, buckwheat, kudzu, oca, sorghum, sweet potato, taro, yam, banana, cassava, sago, fava, lentil and pea. In some embodiment the starch is made of chickpeas. In some embodiments, the starch is made of red beans. In some embodiments the starch is made of legumes or grains. In some examples, the flour is made of legumes or grains. Sometimes, the legumes comprise alfalfa, clover, peas, beans, lentils, lupins, mesquite, carob, soybeans, peanuts, tamarind or wisteria. In some embodiments, the grains comprise Chickpeas, common beans, common peas (garden peas), fava beans, lentils, lima beans, lupins, mung beans, peanuts, pigeon peas, runner beans or soybeans. In some examples, the legumes are beans. Sometimes, the beans are Vicia faba (also known as broad bean, fava beans), Vigna aconitifolia (also known as Moth bean), Vigna angularis (also known as azuki bean), Vigna mungo (also known as urad bean), Vigna radiata (also known as mung bean), Vigna subterranea (also known as Bambara bean or ground-bean), Vigna umbellatta (also known as rice bean), Vigna unguiculata (also known as cowpea), Cicer arietinum or chickpea (also known as also known as the garbanzo bean), Pisum sativum (also known as pea), Lathyrus sativus (also known as Indian pea), Lathyrus tuberosus (also known as Tuberous pea), Lens, Lentils culinaris (also known as lentil), Lablab Lentils purpureus (also known as hyacinth bean), Hyacinth Beans, Phaseolus acutifolius (also known as tepary bean), Phaseolus coccineus (also known as runner bean), Phaseolus lunatus (also known as lima bean), Phaseolus vulgaris (also known as common bean), Phaseolus polyanthus (also known as Phaseolus Dumosus), Glycine max (also known as soybean), Psophocarpus tetragonolobus (also known as winged bean), Cajanus cajan (also known as pigeon pea), Stizolobium spp (also known as velvet bean), Cyamopsis tetragonoloba (also known as guar), Canavalia ensiformis (also known as jack bean), Canavalia gladiata (also known as sword bean), Macrotyloma uniflorum (also known as horse gram), Lupinus mutabilis (also known as Lupin mutabilis or tarwi), Lupinus albus (also known as lupini bean), Erythrina herbacea (also known as Coral bean), Arachis hypogaea (also known as Peanut). In some instances, the Phaseolus vulgaris comprises pinto bean, kidney bean, black bean, red bean or green beans. In some examples, the Vigna unguiculata comprises black-eyed pea or yard long bean. In some exemplary embodiments, the flour is wheat flour. In some exemplary embodiments, the starch is derived from wheat. In some exemplary embodiments, the beneficial agent is selected from the group consisting of micronutrients, probiotics, prebiotics and vitamins. Sometimes the mixture or suspension does not contain any measurable amount of starch.

In some exemplary embodiments, the mixture or suspension further comprises spices. In some exemplary embodiments, the mixture or suspension further comprises flavors. In some embodiments, the mixture or suspension further comprising aroma. In some examples, the mixture or suspension further comprises colors. In some exemplary embodiments, the mixture or suspension further comprises gelation agents.

In some embodiments, the mixture or suspension further comprises oil. Sometimes, the oil comprises saturated or unsaturated fatty acid moieties. In some exemplary embodiments, the oil is vegetable or animal oil. In some examples, the oil content is less than 1.6% weight by weight. In some occurrences, the oil content is less than 3.0% weight by weight.

In some embodiments, the mixture or suspension further comprises milk. In some exemplary embodiments, the mixture or suspension further comprises an egg. In some examples, the mixture or suspension further comprises an emulsifier. In some instances, the emulsifier is selected from the group consisting of modified starch, pectin, gum, esters, polysorbates, mono-glycerides, di-glycerides and lecithin.

In some examples, the mixture or suspension further comprises an anti-caking agent. In some embodiments, the mixture or suspension comprises a protein.

In a second aspect, the invention relates to a processed edible plant comprising a single intact edible plant section that is coated by a mixture or suspension comprising a) at least one component derived from a ground tissue of multiple plants, and b) at least one component that either mimics or comprises an external plant tissue; wherein a weight by weight percentage of the single intact edible plant section is at most 98 percent of the single intact edible plant section that is coated by the mixture or suspension; wherein a weight by weight percentage of the mixture or suspension is at least one percent of the single intact edible plant section that is coated by the mixture or suspension; wherein the plant tissue is selected from the group consisting of epidermis, periderm, sclerenchyma and phloem; wherein a size of the ground tissue is at least one cell of the plant tissue, and at most five hundred cells of the plant tissue; and wherein the mixture or suspension imparts a texture to the single intact edible plant section upon cooking.

In some embodiments, the edible plant can be substituted for an edible meat.

In some embodiments, the mixture or suspension is a homogenized mixture or suspension.

In some embodiments, the at least one component that mimics an external plant tissue is selected from the group consisting of proteins, electrolytes, oil, and binding agents.

In some embodiments, the at least one component that mimics an external plant tissue is selected from the group consisting of electrolytes.

In some embodiments, the mixture or suspension has a viscosity of at least 0.01 centipoises. In some embodiments, the mixture or suspension viscosity is at most 10,000 centipoises.

In some embodiments, the epidermis comprises cuticle tissue, upper epidermis tissue, lower epidermis tissue, palisade mesophyll, spongy mesophyll, vascular bundle, stoma complex, pavement cells, trichome cells, and conical cells. In some embodiments, the plant vascular bundle comprises sheath, xylem and phloem.

In some embodiments, the texture is selected from the group consisting of hard, crunchy, crispy, crumbly, brittle and resilient. In some embodiments, the crispy texture is maintained at least one day after said cooking. In some embodiments, the crispy texture imparts a peak force of at least 10 Newtons per gram. In some embodiments, the crispy texture has a moisture content of at most 35 weight by weight percent of water as compared to the total weight of the crispy texture. In some embodiments, the crispy texture imparts an ultrasonic velocity of at least 100 minutes per second. In some embodiments, the crispy texture transmission loss of at least 0.20 dB/mm. In some embodiments, the texture imparts a desired mouth-feel upon said ingestible item. In some embodiments, the desired mouth-feel is a crispy mouth feel. In some embodiments, the desired mouth-feel is selected from the group consisting of crispy, crunchy, crusty, brittle, not-soggy, not-soft, crumbly and hard.

In some embodiments, the cooked mixture or suspension alters said migration of at least one of active-ingredient, nutrient, toxin. In some embodiments, the cooked mixture or suspension alters at least one of oxidation or discoloration, of said ingestible item.

In some embodiments, the cooking comprises baking. In some embodiments, the baking is baking in a temperature of at least 25 degrees Celsius. In some embodiments, the baking is baking in a temperature of at most 350 degrees Celsius. In some embodiments, the cooking comprises frying, microwaving, freezing, boiling, sautéing, broiling or grilling.

In some embodiments, the ingestible item comprises an edible substance selected from the group consisting of a carbohydrate, a protein, oil, and a nucleic acid. In some embodiments, the ingestible item comprises a vegetable, a fruit, a meat or a pharmaceutical. In some embodiments, the vegetable is a root vegetable. In some embodiments, the root vegetable is a potato. In some embodiments, the root vegetable is a sweet-potato. In some embodiments, the fruit is a Musa plant. In some embodiments, the Musa is a banana or plantain.

In some embodiments, the cooked coating is of thickness of at least 0.01 micrometer. In some embodiments, the cooked coating is of thickness of at most 5,000 micrometer.

In some embodiments, the processed ingestible plant further comprises adding a second coating on said final coated ingestible item. In some embodiments, the second coating is selected from the group consisting of said homogenized mixture or suspension, bread crumbs, batter and cereal.

In some embodiments, the ground tissue comprises at least one weight by weight percent of said mixture or suspension. In some embodiments, the ground tissue comprises at least five weight by weight percent of said mixture or suspension. In some embodiments, the coated by said mixture or suspension comprises covering at least 75 percent of said ingestible item with said mixture or suspension.

In some embodiments, the edible plant comprises an edible plant parts selected from the group consisting of roots, stems, leaves, flowers, fruits, bark and seeds. In some embodiments, the edible plant is selected from said edible plant group consisting of root vegetables, root-like vegetable stem, modified plant stems and plant bulbs. In some embodiments, the edible plant comprises potato. In some embodiments, the edible plant is an edible cactus. In some embodiments, the cactus at least one of aloe Vera or Opuntia.

In some embodiments, the mixture or suspension comprises particles of at least 0.001 micrometers. In some embodiments, the mixture or suspension comprises particles of at most 20,000 micrometers.

In some embodiments, the mixture or suspension further comprising cellulose. In some embodiments, the cellulose is selected from the group consisting of cellulose, hemicellulose, modified cellulose and modified hemicellulose. In some embodiments, the hemicellulose is selected from the group consisting of xylooligosaccharides, glucoronoxylan, arabinoxylan, glucomannan and xyloglucan.

In some embodiments, the modified cellulose is selected from the group consisting of methyl cellulose, ethyl cellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose and carboxymethyl cellulose, or combinations thereof. In some embodiments, the mixture or suspension further comprises a monosaccharide, a disaccharide or an oligosaccharide.

In some embodiments, the mixture or suspension further comprises a binding agent. In some embodiments, the binding agent is selected from the group consisting of starch, pectin and gelatin. In some embodiments, the starch is derived from said plant selected from the group consisting of potato, corn, rice, wheat, barley, oat, tapioca, arrow root, guar gum, locust bean, arracacha, buckwheat, kudzu, oca, sorghum, sweet potato, taro, yam, banana, cassava, sago, fava, lentil and pea. In some embodiments, the wherein said starch is contain in flour. In some embodiments, the flour is made from the plant selected from the group consisting of potato, corn, rice, wheat, barley, oat, tapioca, arrow root, guar gum, locust bean, arracacha, buckwheat, kudzu, oca, sorghum, sweet potato, taro, yam, banana, cassava, sago, fava, lentil and pea. In some embodiments, the starch is derived from the plant selected from the group consisting of potato, corn, rice, wheat, barley, oat, tapioca, arrow root, guar gum, locust bean, arracacha, buckwheat, kudzu, oca, sorghum, sweet potato, taro, yam, banana, cassava, sago, fava, lentil and pea. In some exemplary embodiments, the flour is wheat flour. In some embodiments, the flour is wheat flour.

In some embodiments, the mixture or suspension further comprises a beneficial agent. In some embodiments, the beneficial agent is selected from the group consisting of micronutrients, probiotics, prebiotics, sterols or stanols, anti-oxidants, and vitamins.

In some embodiments, the mixture or suspension further comprises spices. In some embodiments, the mixture or suspension further comprises flavors. In some embodiments, the mixture or suspension further comprises aroma. In some embodiments, the mixture or suspension further comprises colors. In some embodiments, the mixture or suspension further comprises gelation agents. In some embodiments, the mixture or suspension further comprises oil. In some embodiments, the oil comprises saturated or unsaturated fatty acid moieties.

In some embodiments, the oil is vegetable or animal oil. In some embodiments, the oil content is less than 1.6% weight by weight.

In some embodiments, the mixture or suspension further comprises an emulsifier. In some embodiments, the emulsifier is selected from the group consisting of modified starch, pectin, gum, esters, polysorbates, mono-glycerides, di-glycerides and lecithin.

In some embodiments, the oil content is less than 3.0% weight by weight. In some embodiments, the mixture or suspension further comprises milk. In some embodiments, the mixture or suspension further comprises an egg. In some embodiments, the mixture or suspension further comprises an anti-caking agent. In some embodiments, the mixture or suspension further comprises a protein.

In a third aspect, the invention relates to a method for distributing an ingestible item having a desired texture, comprising the steps of: a)grinding at least a section of an edible plant tissue to form a multiplicity of ground edible plant tissue parts; wherein the size of the ground edible plant tissue parts is at least one cell of the edible plant tissue, and at most one hundred cells of the edible plant tissue, and wherein the edible plant tissue is selected from the group consisting of epidermis, periderm, sclerenchyma and phloem; b) preparing a homogenized mixture or suspension comprising a fluid and the ground edible plant tissue parts; wherein the homogenized mixture or suspension has a viscosity of at least 0.01 centipoises; c) coating an ingestible item with the homogenized mixture or suspension to form a final coated ingestible item; d)cooking the final coated ingestible item to form an ingestible item having the desired texture, wherein the cooked coating imparts an external texture on the ingestible item, wherein the external texture remains essentially intact for at least eight hours day after the cooking; and e) providing the ingestible item having the desired texture in exchange for a fee.

In some exemplary embodiments relating to any of the abovementioned aspects of the invention the ground edible plant tissue parts comprises modified ground edible plant tissue parts. Sometimes, the modified comprises physical or chemical modification. In some embodiments, the physical or chemical modification is selected from the group consisting of pregelatinization, annealing, extrusion, oxidation utilizing an oxidation reagent, esterification utilizing an esterification reagent, crosslinking utilizing a crosslinking reagent, hydrolysis utilizing a hydrolysis agent, and enzyme hydrolysis using an enzyme hydrolysis agent.

In some aspects, the hydrolysis is acid hydrolysis or basic hydrolysis. Sometimes, the hydrolysis is acid hydrolysis. In some examples, the hydrolysis agent comprises alpha-amylase, beta-amylase, gamma-amylase, glucoamylase, Pullulanaseor isoamylase. Glucoamylase is also known as glucoamylase, amyloglucosidase, gamma-amylase, lysosomal alpha-glucosidase, acid maltase, exo-1,4-alpha-glucosidase, glucose amylase, gamma-1,4-glucan glucohydrolase, acid maltase and 1,4-alpha-D-glucan glucohydrolase or combinations thereof. Pullulanase is also known as limit dextrinase, amylopectin 6-glucanohydrolase, bacterial debranching enzyme, debranching enzyme, alpha-dextrin endo-1,6-alpha-glucosidase, R-enzyme, pullulan alpha-1,6-glucanohydrolase. Isoamylase is also known as debranching enzyme, glycogen alpha-1,6-glucanohydrolase.

In some embodiments, the extrusion is performed at a temperature of at least 90° C. and at most 300° C. Sometimes, the extrusion is performed at a residence time of at least 1 second to at most 90 seconds. At times, the extrusion is comprises reactive extrusion, thermoplastic extrusion or enzyme catalyzed regioselective modification. In some instances, the extrusion is performed (a) at a temperature of at least 90° C. and at most 300° C. and (b) at a residence time between at least 1 second and at most 90 seconds; and wherein said extrusion comprises reactive extrusion, thermoplastic extrusion or enzyme catalyzed regio-selective modification. Occasionally, the extrusion takes place at a temperature of at least 85° C. at and most 275° C. In some examples, the extrusion through the dye takes place at a resistance time of at least 0.001 seconds and at most 60 seconds.

In some exemplary embodiments, the crosslinking reagent comprises phosphoryl chloride, adipic acetic mixed anhydride, sodium trimetaphosphate, mixtures of sodium trimetaphosphate or mixtures of tripolyphosphates. Sometimes, the crosslinking comprises tripolyphosphates at a pH above 11 at a temperature of at least 20° C. and at most 32° C. In some examples, the crosslinking comprises tripolyphosphates at a pH above 11 at a temperature of 25° C.

In some embodiments, the esterification reagent comprises succinic anhydride, 1-octenyl succinic anhydride, acetic anhydride, vinyl acetate, alkenyl substituted succinic anhydride, sodium tripolyphosphate, or propylene oxide. Sometimes, the etherification at a temperature of at least 20° C. and at most 65° C. In some examples, the etherification at a temperatures of at least 26° C. and at most 30° C. In some instances, the etherification takes place at a pH of at least 3.9 and at most 12. Occasionally, the etherification takes place at a pH of 8. In some embodiments, the etherification requires a subsequent pH adjustment of at least 6 and at most 7. In some examples, the etherification using propylene oxide takes place at a temperature between at least 40° C. and at most 45° C. In some instances, the etherification using propylene oxide takes place at a pH of at least 10 and at most 12. In some embodiments, the etherification using propylene oxide takes place at a pH of 11.5. Sometimes, the etherification using propylene oxide further comprises wash.

In some exemplary embodiments the oxidation reagent comprises sodium hypochlorite, sodium chlorite, hydrogen peroxide, peracetic acid or potassium permanganate. In some examples, the oxidation is conducted at a pH of at least 2.0 and at most 12. Sometimes, the oxidation is conducted at a pH 7. Occasionally, the oxidation is conducted at a temperature between at least 20° C. and at most 60° C. At times, the oxidation is conducted at a temperature between at least 25° C. and at most 45° C.

In one aspect, the invention relates to a method for coating an ingestible item comprising: a) grinding plant tissue to generate ground edible plant parts wherein said ground edible plant tissue parts comprises at least one cell and at most one hundred cells; b) preparing a mixture comprising said ground edible plant tissue and coating an ingestible item with said mixture, wherein said mixture has a viscosity of at least 0.01 centipoises; c) baking said ingestible item wherein an external texture is imparted that remains essentially intact for at least two hours.

In some exemplary embodiments, the external texture imparts a crispy, crunchy, crusty, brittle, not-soggy, not-soft, crumbly or hard mouth-feel, has a peak force of at least 10 Newtons per gram, has a moisture content of at most 35 weight by weight percent of water, has an ultrasonic velocity of at least 100 minutes per second, and has a transmission loss of at least 0.20 dB/mm.

In some exemplary, the ingestible item comprises a vegetable, a fruit, a meat, or a pharmaceutical. In some exemplary embodiments, the ground edible plant tissue parts comprises particles of at least 0.001 micrometers and at most 5,000 micrometers in size, and comprises at most 0.5 weight by weight percent of said mixture coating. In some exemplary embodiments, the mixture comprises cellulose, hemicellulose, modified cellulose or modified hemicellulose. In some embodiments, the mixture comprises a binding agent. In some exemplary embodiments, the mixture comprises an emulsifier.

In another aspect, the invention relates to a processed ingestible plant section that is coated by a mixture comprising: a) at least one component derived from a ground plant tissue of multiple plants, wherein a size of plant tissue is at least one cell and at most one hundred cells; and b) at least one component that either mimics or comprises an external plant tissue, wherein a weight by weight percentage of plant section is at most 99 percent and a weight by weight percentage of said mixture is at least 0.5 percent of said plant section.

In some exemplary embodiments, the mixture or suspension has a viscosity of at least 0.01 centipoises. In some exemplary embodiments, the coating mixture imparts a crispy, crunchy, crusty, brittle, not-soggy, not-soft, crumbly or hard mouth-feel, has a peak force of at least 10 Newtons per gram, has a moisture content of at most 35 weight by weight percent of water, has an ultrasonic velocity of at least 100 minutes per second, and has a transmission loss of at least 0.20 dB/mm.

In some exemplary embodiments, the ingestible item comprises a vegetable, a fruit, a meat, or a pharmaceutical. In some embodiments, the ground edible plant tissue parts comprises particles of at least 0.001 micrometers and at most 5,000 micrometers in size, and comprises at most 0.5 weight by weight percent of said mixture coating.

In some exemplary embodiments, the mixture comprises cellulose, hemicellulose, modified cellulose or modified hemicellulose. In some embodiments, the mixture comprises a binding agent. In some exemplary embodiments, the mixture comprises an emulsifier. In some exemplary embodiments, the oil content is less than 1.6% weight by weight.

In another aspect, the invention relates to a method for distributing an ingestible item having a desired texture, comprising the steps of: a) grinding plant tissue wherein a size of plant tissue is at least one cell and at most one hundred cells; b) preparing a mixture of ground plant tissue and coating an ingestible item with said mixture, wherein said mixture has a viscosity of at least 0.01 centipoises; c) baking said ingestible item wherein an external texture is imparted that remains essentially intact for at least two hours; and d) providing said ingestible item in exchange for a fee.

In another aspect, the invention relates to a method for coating an ingestible item comprising: a) subjecting the surface of the ingestible item to undergo a chemical reaction with an active agent for at least one second and at most ninety seconds; and b) baking said ingestible item wherein an external texture is imparted that remains essentially intact for at least two hours.

In another aspect, the invention relates to a method for encapsulation an ingestible item comprising: a) subjecting the surface of the ingestible item to undergo a chemical reaction with an active agent for at least one second and at most ninety seconds; and b) coating the ingestible item with a mixture of ground plant tissue, wherein a size of plant tissue is at least one cell and at most one hundred cells, and c) baking said ingestible item wherein an external texture is imparted that remains essentially intact for at least two hours.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1: Schematic illustration of a system in accordance with an embodiment of the present disclosure for the making of a coated ingestible item having a desired texture.

FIG. 2: Schematic diagram of the computer system.

### DETAILED DESCRIPTION OF THE INVENTION

The present invention relates to a method for coating an ingestible item with a coating that imparts a certain long lasting texture to the ingestible item. In some instances, the ingestible item is an edible food item. Sometimes, the ingestible item is a vegetable, a fruit, a meat, an egg, seafood, a synthetic food product or a pharmaceutical.

In some embodiments the ingestible item is targeted to ingestion by a human. In some embodiments the edible item is edible for a human. In some embodiments the ingestible item is targeted to ingestion by an animal. In some embodiments the edible item is edible for an animal. Sometimes, an animal is a pet, laboratory animal, farm animal or wild animal. In some instances, the human is a healthy human. In some examples, the human is a human that is not healthy. In some embodiments the ingestible item is targeted to ingestion by vertebrates, mollusks, arthropods, annelids or sponges. In some embodiments the edible item is edible for vertebrates, mollusks, arthropods, annelids or sponges. Sometimes, the animal is a bird, mammal, amphibian, reptile or fish. Sometimes, the vertebrate is a bird, mammal, amphibian, reptile or fish. In some instances, the mammal is a primate, ape, dog, cat, rodent, rabbit or ferret. In some instances, the rodent is a gerbil, hamster, chinchilla, fancy rat, or guinea pig. In some instances, the bird is a canary, parakeet or parrots. In some examples, the reptile is a turtles, lizard or snake. In some instances, the fish is a tropical fish. In some instances, the amphibian is a frog. In some instances the arthropod is a tarantula or hermit crab.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Before the present methods and compositions are described, it is to be understood that this invention is not limited to particular method or composition described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

It must be noted that as used herein and in the appended claims, the singular forms “a”, “an”, and “the” include plural referents unless the context clearly dictates otherwise.

In some aspects, the coating mimics an external tissue of a plant. For example, the coating mimics a plant epidermis tissue, periderm tissue, sclerenchyma tissue, phloem tissue, or any combination thereof. In some exemplary embodiments, the coating mimics an epidermis plant tissue. In some occurrences, mimicking of an epidermis tissue comprises mimicking any one of a plant cuticle tissue, upper epidermis tissue, lower epidermis tissue, palisade mesophyll, spongy mesophyll, vascular bundle, stoma complex, pavement cells, trichome cells, conical cells, or any combination thereof. Sometimes, mimicking the plant vascular bundle comprises mimicking any one of the plant sheath, xylem, phloem, or any combination thereof.

In some exemplary embodiments, mimicking an external plant tissue comprises coating the ingestible item with cells or cell clusters that are derived from the external plant tissue. In some instances, mimicking additionally comprises coating the ingestible item with at least one of proteins, electrolytes, fatty acid, oily compound or a binding agent that is either present in the external plant tissue, or resembles substances that are present in the external plant tissue. In some examples, the protein is derived from the external plant tissue, or mimics a proteins that is present in the external plant tissue. Sometimes, the fatty acid is derived from the external plant tissue, or mimics a fatty acid that is present in the external plant tissue. Sometimes, the oily compound is derived from the external plant tissue, or mimics an oily compound that is present in the external plant tissue. Sometimes, the binding agent is derived from the external plant tissue, or mimics a binding agent that is present in the external plant tissue. Occasionally, the electrolyte is derived from the external plant tissue, or mimics the properties of an electrolyte that is present in the external plant tissue. In some exemplary embodiments, mimicking comprises mimicking the properties of the external plant tissue. The properties comprises retention of humidity level, retention of texture, wettability, crunchiness, brittleness, resistance to spoilage, resistance to microorganisms, resistance to light, flexibility, cohesiveness, or any combination thereof. The microorganisms comprise invertebrates, worms, insects, fungi, yeast, bacteria or virus. In some embodiments, insects are fruit flies. In some instances, mimicking comprises mimicking the texture of the external plant tissue. In some exemplary embodiments, mimicking comprises mimicking the appearance of the external plant tissue. Examples of electrolytes comprise salts of sodium, potassium, magnesium, calcium, chloride, phosphate, iron, copper, zinc, manganese, cobalt, vanadium, chromium, selenium, molybdenum, nickel, boron, silica, silicon, fluorine, iodine, arsenic and the like. In some embodiments, the mixture or suspension does not comprise salt. Sometimes, the mixture or suspension is an emulsion, cream or blend.

In some aspects, the invention also describes a method for coating an ingestible item with a mixture or a suspension that imparts texture or beneficial features to the ingestible item. Occasionally, the texture or beneficial features is imparted upon coating, or upon coating and cooking of the coated ingestible item.

In some examples, the method comprises parceling at least a section of an edible plant tissue to form a multiplicity of ground edible plant tissue parts and coating an ingestible item with the multiplicity of ground edible plant tissue parts on. In some instances, the parceling comprises grinding, mincing, chopping, shredding, crumbling, cutting, hashing, or any combination thereof. In one embodiment, the method comprises grinding at least a section of an edible plant tissue to form a multiplicity of ground edible plant tissue parts and coating an ingestible item with the multiplicity of ground edible plant tissue parts on.

In some instances, the plant tissue part is a plant tissue segment, plant tissue section, plant tissue piece, plant tissue slice, plant tissue sector, plant tissue division, plant tissue fragment, plant tissue portion, plant tissue bit, plan tissue chunk, plant tissue lump, plant tissue amount, plant tissue sliver, plant tissue block or plant tissue wedge.

In some examples, the edible plant tissue is derived from a plant epidermis, periderm, sclerenchyma or phloem. In some exemplary embodiments, the ingestible item is a single intact part of a tissue such as an animal or plant tissue. In some embodiments, the ingestible item is comprised of at least two parts of a single tissue. In some aspects, the ingestible item is comprised of at least two parts, each derived from a different tissue. In some exemplary embodiments, the ingestible item is comprised of at least one tissue part and at least one synthetic compound. In some examples, the ingestible item is comprised at least one synthetic compound.

In some embodiments, the size of the ground edible plant tissue part is as small as one cell of the edible plant tissue. In some instances, the ground edible plant tissue part is at least five cells, 10 cells, 25 cells, 50 cells, 75 cells, 100 cells, 150 cells, 200 cells, 400 cells, 600 cells, 800 cells, 1,000 cells, 1,500 cells, 2,000 cells, 3,000 cells, 5,000 cells, 7,500 cells, 10,000 cells, 15,000 cells, 20,000 cells, 50,000 cells, 75,000 cells, 100,000 cells, 500,000 cells, 1,000,000 cells, 1,500,000 cells, 2,000,000 cells, 4,000,000 cells, 6,000,000 cells, 8,000,000 cells, 10,000,000 cells, 15,000,000 cells, 20,000,000 cells, 100,000,000 cells or more. In some examples, the ground edible plant tissue is at most from five cells, 10 cells, 25 cells, 50 cells, 75 cells, 100 cells, 150 cells, 200 cells, 400 cells, 600 cells, 800 cells, 1,000 cells, 1,500 cells, 2,000 cells, 3,000 cells, 5,000 cells, 7,500 cells, 10,000 cells, 15,000 cells, 20,000 cells, 50,000 cells, 75,000 cells, 100,000 cells, 500,000 cells, 1,000,000 cells, 1,500,000 cells, 2,000,000 cells, 4,000,000 cells, 6,000,000 cells, 8,000,000 cells, 10,000,000 cells, 15,000,000 cells, 20,000,000 cells, 100,000,000 cells or less.

In some exemplary embodiments, the size of the ground edible plant tissue part is at least 1 nanometer, 10 nanometers, 15 nanometers, 20 nanometers, 30 nanometers, 40 nanometers, 50 nanometers, 60 nanometers, 70 nanometers, 80 nanometers, 90 nanometers, 100 nanometers, 250 nanometers, 500 nanometers, 750 nanometers, 1,000 nanometers, 2,500 nanometers, 5,000 nanometers, 7,500 nanometers, 10,000 nanometers, 25,000 nanometers, 50,000 nanometers, 75,000 nanometers, 100,000 nanometers, 250,000 nanometers, 500,000 nanometers, 750,000 nanometers, 1,000,000 nanometers, 2,500,000 nanometers, 5,000,000 nanometers, 7,500,000 nanometers, 10,000,000 nanometers, 25,000,000 nanometers, or at least 50,000,000 nanometers. In some embodiments, the size of the ground edible plant tissue is at most 2 nanometers, 5 nanometers, 10 nanometers, 15 nanometers, 20 nanometers, 30 nanometers, 40 nanometers, 50 nanometers, 60 nanometers, 70 nanometers, 80 nanometers, 90 nanometers, 100 nanometers, 250 nanometers, 500 nanometers 750 nanometers, 1,000 nanometers, 2,500 nanometers, 5,000 nanometers, 7,500 nanometers, 10,000 nanometers, 25,000 nanometers, 50,000 nanometers, 75,000 nanometers, 100,000 nanometers, 250,000 nanometers, 500,000 nanometers, 750,000 nanometers, 1,000,000 nanometers, 2,500,000 nanometers, 5,000,000 nanometers, 7,500,000 nanometers, 10,000,000 nanometers, 25,000,000 nanometers, 50,000,000 nanometers or at most 100,000,000 nanometers.

In some exemplary embodiments, the method comprises preparing a mixture or suspension comprising the ground edible plant tissue parts and a fluid. In some embodiments, the fluid is a liquid or a gas. In some embodiments, the fluid comprises water, an aqueous solution, an oily solution or an oil-in-water suspension. The fluid comprises volatile organic compounds. For example, the volatile organic compound comprises any alcoholic compound such as ethanol. Occasionally, the fluid comprises gelation agents. Sometimes, the mixture or suspension is homogenous or non-homogenous.

In some exemplary embodiments, the mixture or suspension is have a viscosity of at least 0.01 centipoises (cP), 0.05 cP, 0.1 cP, 0.5 cP, 1.0 cP, 5.0 cP, 10 cP, 25 cP, 50 cP, 75 cP, 100 cP, 250 cP, 500 cP, 750 cP, 1,000 cP, 2,500 cP, 5,000 cP, 7,500 cP, 10,000 cP, 25,000 cP, 50,000 cP, 75,000 cP, 100,000 cP, 250,000 cP, 500,000 cP, 750,000 cP, 1,000,000 cP, 2,500,000 cP, 5,000,000 cP, 7,500,000 cP, 10,000,000 cP, 25,000,000 cP or at least 50,000,000 cP. In some embodiments, the homogenous mixture or suspension is have a viscosity of at most 0.01 centipoises (cP), 0.05 cP, 0.1 cP, 0.5 cP, 1.0 cP, 5.0 cP, 10 cP, 25 cP, 50 cP, 75 cP, 100 cP, 250 cP, 500 cP, 750 cP, 1,000 cP, 2,500 cP, 5,000 cP, 7,500 cP, 10,000 cP, 25,000 cP, 50,000 cP, 75,000 cP, 100,000 cP, 250,000 cP, 500,000 cP, 750,000 cP, 1,000,000 cP, 2,500,000 cP, 5,000,000 cP, 7,500,000 cP, 10,000,000 cP, 25,000,000 cP or at most 50,000,000 cP. In some examples, the mixture or suspension is homogenous. In some aspects the mixture or suspension is non-homogenous. In some aspects the mixture or suspension is heterogeneous.

In some examples, the coating of the ingestible item with the mixture or suspension comprises covering 10%, 15%, 20%, 25%, 30%, 35%, 40%, 45%, 50%, 55%, 60%, 65%, 70%, 75%, 80%, 85%, 90%, 95%, 100% or excessive coating of the ingestible item with the mixture or suspension. Excessive coating of the ingestible item comprises coating that results in dripping of the covered mixture or suspension from the coated ingestible item after at least 1 minute, 5 minutes, 10 minutes, 20 minutes, 30 minutes, 40 minutes, 50 minutes, 60 minutes, 70 minutes, 80 minutes or more after the coating was applied on the ingestible item.

In some exemplary embodiments, when the coating is excessive, the method further comprises removing access of coating to obtain a coated ingestible item. In some examples, a coated ingestible item excludes excessively covered or excessively coated ingestible item. In some embodiments, the coated ingestible item comprises covering up to 10%, 15%, 20%, 25%, 30%, 35%, 40%, 45%, 50%, 55%, 60%, 65%, 70%, 75%, 80%, 85%, 90%, 95% or up to 100% of the ingestible item with the coating.

In some exemplary embodiments, the final coated ingestible item comprises a coating that is at least 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9 or at least 10 weight by weight percent of the coated ingestible item. In some exemplary embodiments, the final coated ingestible item comprises a coating that is at most 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9, 10, 20, 30, 40 or at most 50 weight by weight percent of the coated ingestible item.

In some embodiments, the final coated ingestible item comprises a coating that is of a thickness of at least 0.0001, 0.002, 0.003, 0.004, 0.005, 0.006, 0.007, 0.008, 0.009, 0.01, 0.02, 0.03, 0.04, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9, 10, 20, 30, 40, 50, 75, 100, 250, 500, 750, 1,000, 2,500, 5,000, 7,500, 10,000, 25,000, 50,000, 75,000, 100,000 or at least 200,000 micrometers. In some instances, the final coated ingestible item comprises a coating that is at most 0.002, 0.003, 0.004, 0.005, 0.006, 0.007, 0.008, 0.009, 0.01, 0.02, 0.03, 0.04, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 10, 20, 30, 40, 50, 75, 100, 250, 500, 750, 1,000, 2,500, 5,000, 7,500, 10,000, 25,000, 50,000, 75,000, 100,000, 250,000, 500,000, 750,000, 1,000,000, 2,500,000, 5,000,000, 7,500,000, 10,000,000, 25,000,000 or at most 50,000,000 micrometers.

In some aspects, the coating (e.g. the mixture or suspension) is heterogeneous or homogenous. In some embodiments, the ground edible plant tissue parts comprises at least 0.01%, 0.05%, 0.1%, 0.5%, 1%, 2%, 3%, 4%, 5%, 6%, 7%, 8%, 9%, 10%, 15%, 20%, 25%, 30%, 35%, 40%, 45%, 50% or at least 55% weight by weight percent of the total weight of the mixture or suspension. In some examples, the ground edible plant tissue parts comprises at most 0.01%, 0.05%, 0.1%, 0.5%, 1%, 2%, 3%, 4%, 5%, 6%, 7%, 8%, 9%, 10%, 15%, 20%, 25%, 30%, 35%, 40%, 45%, 50% or at most 55% weight by weight percent of the total weight of the mixture or suspension (i.e. the coating).

In some exemplary embodiments, the method also comprises adding a second coating on the final coated edible item. In some instances, the second coating comprises breading, batter or an additional layer of the mixture or suspension (i.e. the coating). In some examples, breading comprises bread crumbs, whole nuts, shredded nuts, whole seeds, shredded seeds, whole cereal, shredded cereal or shredded cereal products. In some examples, bread crumbs comprise any ground bread, panko (Japanese bread crumbs), cracker, biscuit, cake, or any baked dough. Sometimes, bread crumbs vary in their level of humidity. In some examples, bread crumbs are made from stale bread (old bread), fresh bread, dry bread, humid bread or any combination thereof. In some instances, bread crumbs also comprise spices. In some examples, the nuts are coconut, almond, chestnut, hazelnut, walnut, cashew, brazil nut, pine nut, hickory, bread nut, Ginko nut, Macadamia, peanut, Paradise nut, Araucaria, Cycad, Bunya nut or any combination thereof. In some examples, the seeds are sesame, poppy, pumpkin, chia, flax, quinoa, mustard, sunflower, rapeseed, hemp or any combination thereof. Sometimes the mustard seed is rapeseed, black mustard or India mustard. In some instances, the bread crumbs is of any bread such as rye, whole wheat, white, sprouted bread, or any combination thereof. In some aspects, the cereal is wheat, rye, barley, corn, millet, oatmeal, spelt, sorghum, teff, triticale, wild rice, Palmer's grass, fonio or any combination thereof.

In some embodiments, the method comprises cooking the final coated item to form an ingestible item having a cooked coating such that the cooked coating imparts an external texture on the ingestible item.

In one example, the cooked coating is retains the texture of the cooked coating for a prolonged period of time. In some aspects, the retention of texture in refers to a texture that will remain intact as sensed by an average mouth, as compared to the texture obtained on the completion of the cooking step. For example, the retention of the cooked texture is last for at least 0.2 hours, 0.4 hours, 0.5 hours, 0.6 hours, 0.8 hours, 1 hour, 5 hours, 10 hours, 20 hours, 30 hours, 40 hours, 50 hours, 60 hours, 70 hours, 80 hours or more after the coating was cooked. For example, the retention of the cooked texture is last for at most 1 hour, 5 hours, 10 hours, 20 hours, 30 hours, 40 hours, 50 hours, 60 hours, 70 hours, 80 hours or less after the coating was cooked. In some instances, the retention of the cooked texture is last for at most 1 day, 2 days, 3 days, 4 days, 5 days, 6 days, 7 days, 8 days, 9 days, 10 days, 11 days, 12 days, 13 days, 14 days, 15 days, 16 days, 17 days, 18 days 19 days 20 days or less after the coating was cooked. In some instances, the retention of the cooked texture is last for at least 0.5 day, 1 day, 2 days, 3 days, 4 days, 5 days, 6 days, 7 days, 8 days, 9 days, 10 days, 11 days, 12 days, 13 days, 14 days, 15 days, 16 days, 17 days, 18 days 19 days 20 days or more after the coating was cooked. In one example, the retention of texture refers to a cooked coating that will retain a level of humidity that is substantially similar to the level of humidity obtained on the completion of the cooking step. In one instance, the substantial similar humidity is amount to a humidity level that is increased by at most 1%, 2%, 3%, 4%, 5%, 6%, 7%, 8%, 9%, 10%, 11%, 12%, 13%, 14%, 15%, 16%, 17%, 18%, 19%, 20% , 25%, 30%, 35%, 40%, 45%, 50%, 55%, 60%, 65%, 70%, 75%, 80% or 85% as compared to the level of humidity measured in the coating at the completion of the cooking step.

In some exemplary embodiments, the mixture of suspension is uniform. In some exemplary embodiments, the mixture of suspension is even. In some instances, the mixture of suspension is stable over a certain period of time that is longer than the time required for the coating of the ingestible item. Sometimes, the mixture of suspension is not heterogeneous. In some examples, the mixture of suspension is not rough. In some embodiments, the mixture of suspension is smooth. In some examples the smoothness is smooth to the eye, smooth to the touch. The homogenous suspension comprises particles of at least 0.0001, 0.002, 0.003, 0.004, 0.005, 0.006, 0.007, 0.008, 0.009, 0.01, 0.02, 0.03, 0.04, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9, 10, 20, 30, 40, 50, 75, 100, 250, 500, 750, 1,000, 2,500, 5,000, 7,500, 10,000, 25,000, 50,000, 75,000, 100,000 or at least 200,000 micrometers radius. In some examples, the mixture of suspension is homogenous. Sometimes, the homogenous suspension comprises particles of at most 0.0001, 0.002, 0.003, 0.004, 0.005, 0.006, 0.007, 0.008, 0.009, 0.01, 0.02, 0.03, 0.04, 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9, 10, 20, 30, 40, 50, 75, 100, 250, 500, 750, 1,000, 2,500, 5,000, 7,500, 10,000, 25,000, 50,000, 75,000, 100,000 or at most 200,000 micrometers diameter.

Sometimes, the texture of the cooked coating is hardness, crunchiness, crispiness or degree of resilience. In some exemplary embodiments, the texture of the cooked coating is a crispy texture. In some examples, the texture of the cooked coating is a crunchy texture. In embodiments, the texture of the cooked coating is a crusty texture. Sometimes, the texture of the cooked coating is a brittle texture. In some exemplary embodiments, the texture of the cooked coating is a crisp texture. Sometimes, the texture of the cooked coating is a fragile texture. In some exemplary embodiments, the texture of the cooked coating is a frail texture. In some embodiments, the texture of the cooked coating is a breakable texture. In some exemplary embodiments, the texture of the cooked coating is not a soggy texture. In some examples, the texture of the cooked coating is not a soft texture. Sometimes, the texture of the cooked coating is a crumbly texture. Sometimes, the texture refers to a certain mouth-feel. At times, the mouth-feel is evaluated from the initial perception on the palate (roof of the mouth), to first bite, through mastication (i.e. chewing, munching, grinding or champing) to swallowing and aftertaste which is perceived immediately after that food or beverage is removed from the mouth. In some occurrences, the desired mouth-feel is refer to the cohesiveness, density, dryness, wetness, moisture absorption, moisture release, fracturability, graininess, hardness, heaviness, mouth-coating, roughness, slipperiness, viscosity, gumminess, smoothness, uniformity of coating, uniformity of bite force or uniformity of chewing force. In some embodiments, the mouth feel is selected from the group consisting of crunchy, crusty, brittle, crispy, not-soggy, not-soft, hard and crumbly.

In some embodiments, the mixture or suspension is also incorporates at least one additional target ingredient. Sometimes, the target ingredient is an active ingredient, nutrient, medicament, anti-toxin or a beneficial substance. In some examples, the mixture is alters the release of the target ingredient with no cooking, after cooking, or both before and after cooking of the mixture or suspension. In some examples, such alteration of release comprises altering the diffusion coefficient of the target ingredient into the body of the subject ingesting the coated ingestible item. Sometimes, alteration of the diffusion coefficient is amount to slowing down the diffusion of the target ingredient or speeding the diffusion of the target ingredient, as compared to the target ingredient ingested separate from the mixture or suspension. In some examples, the alteration of the diffusion coefficient is amount to slow release of the target ingredient. Sometimes, the slow release is during a prolonged amount of time.

In some embodiments, the coating also alters the oxidation or discoloration of the ingestible item. Sometimes, such alteration is obtained by coating the ingestible item by the mixture or suspension with or without cooking the mixture or suspension. In certain aspects, the coating alters the manner the ingestible item reacts with oxygen, with infra-red, with ultraviolet or with ionizing radiation.

In some exemplary embodiments, cooking the coated ingestible item is performed at least at 4° C., 10° C., 20° C., 40° C., 50° C., 75° C., 100° C., 105° C., 110° C., 120° C., 125° C., 150° C., 200° C., 250° C., 300° C., 350° C., 400° C., 450° C., 500° C., 550° C., 600° C. or at least at 650° C. or more. In some embodiments, cooking the coated ingestible item is performed at most at 30° C., 40° C., 50° C., 75° C., 100° C., 105° C., 110° C., 120° C., 125° C., 150° C., 200° C., 250° C., 300° C., 350° C., 400° C., 450° C., 500° C., 550° C., 600° C. or at most 650° C. or less.

In some exemplary embodiments, cooking is performed at ambient temperatures using a de-humidifier. In some instances, cooking involves a freezing step. In some embodiments, freezing is performed at least at −100° C., −50° C., −30° C., −20° C., −10° C., 0° C., 10° C., 20° C., 30° C., 31° C. or 32° C. In some examples, freezing is performed at most at −100° C., −50° C., −30° C., −20° C., −10° C., 0° C., 10° C., 20° C., 30° C., 31° C., 32° C. or less.

In some embodiments, cooking is performed using a certain cooking method. Sometimes, the cooking method comprises baking, frying, microwaving, freezing, de-humidifying, lyophilizing, slow-cooking, boiling, broiling, grilling, or any combination thereof. At times, frying comprises stir-frying, deep-frying, shallow-frying, pan-frying, sautéing. In certain occurrences, frying is done in any ingestible oil such as any vegetable oil or any animal oil. For example, vegetable oil comprises olive oil, palm oil, soybean oil, canola oil (rapeseed oil), avocado oil, coconut oil, pumpkin seed oil, corn oil, sunflower oil, safflower oil, peanut oil, grape seed oil, sesame oil, agan oil or rice bran oil. Animal oil comprises butter, ghee or lard. Sometimes, the cooking does not include frying.

In certain embodiments, coating the ingestible item is accomplished by spraying, dipping, smearing or immersing. Sometimes, coating is also be performed by using the mixture or suspension as an aerosol.

In certain instances, the ingestible item comprises and edible item. In some exemplary embodiments the edible item comprises a carbohydrate, a protein, an oil or a nucleic acid. In some embodiments the edible item comprises a natural edible item such as vegetable, fruit, egg or meat. In some instances, the meat is poultry, pork, beef, veal, lamb, bison, ostrich, rabbit, game, fish, eel, shell fish, seafood. Sometimes, the poultry is for example poultry chicken, turkey, duck, goose or pigeon. In certain occurrences, the natural edible item comprises the entire intact natural edible item, a selected tissue of the natural edible item or a selected part of a tissue of the natural edible item. In some exemplary embodiments the edible item comprises of intact tissue or tissue part. In some exemplary embodiments the edible item comprises of multiple parts of a tissue part or multiple parts of different tissue parts. In some embodiments the edible item comprises different tissues of a single natural edible item. In examples the edible item comprises different tissues of different natural edible items. Sometimes the edible item comprises synthetic edible substances. At times the edible item is comprised entirely of synthetic edible substances. In certain occurrences the edible item is comprised entirely of one or more natural edible items. In certain aspects, the ingestible item comprises a beneficial substance. An example for a beneficial substance is a synthetic, natural or homeopathic pharmaceutical.

In some exemplary embodiments, the mixture or suspension also comprises a pharmaceutical agent, polymers, fillers and excipients. Occasionally, the pharmaceutical agent is an active agent used for applications under the Anatomical Therapeutic Chemical classification from the WHOCC of the World Health Organization, including, but not limited to, alimentary tract and metabolism, blood and blood forming organs, cardiovascular system, dermatologicals, genito-urinary system and sex hormones, systemic hormonal preparations, excluding hormones and insulin, antiinfectives for systemic use, antineoplastic and immunomodulating agents, musculo-skeletal system, nervous system, antiparasitic products, insecticides and repellents, respiratory system.

Non-limiting examples of fillers and excipients are 1-6 bis(p-carboxyphenoxy)hexane (CPH), poly-CPH (PCPH) and polysebacic anhydride, 4-(2-aminoethyl)benzenesulfonyl fluoride AEBSF, acetyl triethyl citrate, Acetylsalicilic acid, acrylic acid, methacrylic acid, acrylic or methacrylic acid polymers, methacrylates acrylic resins, acrylonitrile/methyl acrylate.maleic anhydride copolymer, albumin, alginate, alginic acid, alkylvinyl polymers, Allura red, Amastatin, amides, amines, ammonio methacrylate copolymers. elastase, anthracycline, ascorbic acid, ascorbic acid compounds, ascorbyl palmitate, Bestatin, BHA, BHT, Brilliant blue, butyl acrylate/styrene.acrylic acid copolymer, butyl acrylate/styrene.maleic anhydride copolymer, butyl methacrylate, butylhydroxyanisole, butylhydroxytoluene, calcium alginate, calcium ascorbate, carbamate, carboxyalkyl cellulose, carboxylmethyl, ethylcellulose, carboxymethylcellulose calcium, carboxymethylcellulose sodium, cellulose acetate, cellulose acetate maleate, cellulose acetate phthalate, cellulose acetate succinate, cellulose benzoate phthalate, cellulose ethers, cellulose nitrate, cellulose propionate, cellulose propionate phthalate, cellulosic polymer, ceramides, cetostearyl alcohol, cetyl alcohol, chitosan, Chlorophyllin, Chymostatin, citric acid, collagenase, croscarmellose sodium, crospovidone, crosscarmellose, cross-linked sodium carboxymethylcellulose, cyclobutyl ether, cyclodextrin, cyclopropyl, dextrin, dibutyl phthalate, dibutyl sebacate, Dicalcium phosphate polysorbate, diethyl phthalate, diethyl sebacate, diethylene glycols, diisopropylfluorophosphate DFP, dimethylaminoethyl methacrylate, dimethylaminoethyl methacrylate copolymers, Diprotin, docusae sodium, esters of ethoxylated trimethylolpropane tri-3-mercaptopropionate, ethyl acrylate, ethyl acrylate/methyl methacrylate/trimethylammonioethyl methacrylate chloride copolymer, ethylcellulose, ethylene oxide and propylene oxide copolymers, ethylene vinyl acetate copolymers, ethylene/maleic anhydride copolymer, Ethylenediamine tetra-acetic acid (EDTA), ethylhydroxyethyl cellulose phthalate, ethylhydroxyethylcellulose, ethylmethylcellulose, gallic acid, gallocatechins, Gelatin, gelatinase, Gellan gum, lutathione, glycol alkyl ether, glycol alkyl ethers, graft copolymers of poly(glycerol-co-sebacic acid) and poly(ethylene glycol), guar gum, hydroquinone, hydroxyalkyl cellulose, hydroxyethylcellulose, hydroxyethylmethylcellulose, hydroxyl propyl cellulose, hydroxymethyl ethylcellulose phthalate, hydroxypropyl cellulose, hydroxypropyl cellulose low-substituted, hydroxypropyl methylcellulose, hydroxypropyl methylcellulose acetate succinate, hydroxypropyl methylcellulose acetate succinate, hydroxypropyl methylcellulose phthalate, hydroxypropyl starch, hylene oxides, Indigotine, lactose, latex, lecithin, lecithin, Leupeptin. L-lactic acid-co-glycolic acid) block co-polymers, L-trans-epoxysuccinylleucylamido (4-guanidino) butane E-64, magnesium aluminium silicate, Magnesium stearate, magnesium stearate, maleic anhydride polymer, Maltodextrin, maltodextrin, maltol, mannitol, mathacrylic copolymer, matrix metalloproteinase, methacrylate chloride copolymer, methacrylic acid copolymers, methacrylic acid polymer or copolymer, methacrylic acid/ethyl acrylate copolymer, methacryllic acid, methyl acrylate.methacrylic acid/octyl acrylate copolymer, methyl acrylate/acrylic acid copolymer, methyl acrylate/acrylic acid copolymer, methyl acrylate/methacrylic acid copolymer, methyl methacrylate, methyl methacrylate, methyl methacrylate/butyl methacrylate/dimethylaminoethyl methacrylate copolymer, methyl methacrylate/butyl methacrylate/dimethylaminoethyl methacrylate copolymer, methyl methacrylate/ethyl acrylate copolymer, methyl peroxide antioxidants, methylcellulose, methylcellulose phthalate, micro crystalline cellulose, Microcrystalline cellulose, mono- and dimethoxypolyethylene glycols (mPEGs), MSG, N-acetyl cysteine, natural or synthetic gum, N-isopropyl acrylamide polymer, nitrile, octyl gallate, oligo (ethylene glycol) methyl methacrylate, oligo (ethylene glycol) methyl methacrylate or poly(N-isopropylacrylamide), p-Amidinophenyl)methanesulfonyl fluoride APMSF, papai, parabens, paraffin, pectin, PEG and polypropylene glycol (PPG) copolymers, pepstatin, phenyl methyl sulfonyl fluoride PMSF, phosphatidylcholine, phosphatidylethanolamine, polacrilin potassium, poloxamers, poly(acrylamide), poly(alkylene glycol), poly(carboxyphenoxy propane)-co-, ebacic acid, poly(ethylene glycol) diacrylate, poly(ethylene , lycol)/poly(D, poly(ethylene oxide-b-propylene oxide-b-ethylene oxide), poly(glycerol-co-sebacic acid) acrylate, poly(lactide-co-glycolide), poly(lactide-co-glycolide), poly(maleic anhydride) ,poly(N-vinyl lactam), poly(olefinic alcohol), poly(oxyethylene)-poly(oxypropylene) block copolymer, poly(vinyl alcohol), polyacrylates, polyacrylic acid, polyalcohols, polyalkylene oxide, polyamide, polyanhydrides, polycaprolactone, polyethylene ,polyethylene glyco 3350, polyethylene, glycol, polyethylene glycol, polyethylene oxide, polyethylene oxide, polyethylene oxide monooleate, polyethylene oxide-polypropylene glycol, polyethylene oxides (PEOs), polyethylene terephtalate, polyglycol, polyglycolic acid and copolymers, polyglycolide, polyhydroxybutyrate, polyhydroxyvalerate, polyimine, polylactic acid, polylactide, polymaleic a cid, polymeric conjugate containing groups such as ether, polyols, polyoxazoline, polyoxyethylated saccharide, polyoxyethylene block, opolymer, polyoxyethylene castor oil derivatives, polyoxyethylene , sorbitan fatty acid esters, polyoxyethylene stearates, polyphosphazines, polypropylene, polypropylene glycol, polypyrrolidone, polysaccharide, polysaccharides, polysebacic anhydride, polyurethane, polyvinyl acetate, polyvinyl acetate phthalate, polyvinyl alcohol, polyvinyl alcohol phthalate, polyvinyl chloride, polyvinylacetal diethylamino acetate, polyvinylacetal diethylamino acetate, polyvinylacetal diethylamino acetate, methyl methacrylate/butyl methacrylate/dimethylaminoethyl , methacrylate copolymer, polyvinylacetal phthalate, polyvinylacetate, polyvinylacetoacetal phthalate, polyvinylamine, polyvinylbutyrate phthalate, polyvinylpyrrolidone, povidone, pregelatinized starch, propylene glycol, propylgallate, retinoids. saccharide, selenium and its compounds, shellac and oils, shellac-based polymer, silica, silica colloidal silicon dioxide, silicone rubber, sodium acetate, sodium alginate, sodium benzoate, sodium bisulfate, sodium carboxymethyl starch, sodium metabisulfate, sodium metabisulfite, sodium starch glycolate, sorbitol, inositol, starch, starch and derivatives, starch and starch-based polymer, stearyl alcohol, stilbenes, stromelysin, styrene/acrylic acid copolymer, styrene/acrylic acid copolymer, styrene-butadienstyrene and styrene-isoprene-styrene, sulfinyl, sulfonyl, talc, tartaric acid, Tartrazine, t-butyl hydroquinone, thioether, thiol esters of ethoxylated trimethylolpropane tri-3-mercaptopropionate and poly(ethylene glycol) diacrylate, thioproline, thrombin, Tissue Inhibitor of Metalloproteinase (TIMP). Titanium dioxide, tocopherol and derivatives, Tosyl-lysine chloromethylketone TLCK, Tosyl-phenyl chloromethylketone TPCK, TPG, TPGS, triacetin, tributyl citrate, triethyl citrate, triethyl citrate, trimethylammonioethyl, ubiquinol, urea, vinyl acetate/maleic anhydride copolymer, vinyl butyl ether/maleic anhydride copolymer, vinylpyrrolidone/vinyl acetate copolymers, vinylpyrrolidone/vinyl acetate copolymers, vitamin compounds, Vitamins, wax, xylitol, zein, zinc and any combination thereof.

In some exemplary embodiments the vegetable is a tuber. The tuber is a stem tuber or a root tuber. For example, the stem tuber is a potato. For example, the root tuber is sweet-potato, cassava (yuca) or yam.

In some examples, the potato is of any edible variety. For example, the potato is of the variety Adirondack Blue, Adirondack Red, Agata, Almond, Alpine Russet, Alturas, Amandine, Annabelle, Anya, Arran Victory, Atlantic, Austrian Crescent, Avalanche, Bamberg, Bannock Russet, Belle de Fontenay, BF-15, Bildtstar, Bintje, Blazer Russet, Blue Congo, Bonnotte, British Queens, Cabritas, Camota, Canela Russet, Cara, Carola, Chelina, Chiloe, Cielo, Clavela Blanca, Desiree, Estima, Fianna, Fingerling, Flava, French Fingerling, German Butterball, Golden Wonder, Goldrush, Home Guard, Innovator, Irish Cobbler, Irish Lumper, Jersey Royal, Kennebec, Kerr's Pink, Kestrel, Keuka Gold, King Edward, Kipfler, Lady Balfour, Langlade, Linda potato, Marcy, Marfona, Maris Piper, Marquis, Megachip, Monalisa, Nicola, Norgold Russet, Pachacoña, Pike, Pink Eye, Pink Fir Apple, Primura, Ranger Russet, Ratte, Record, Red La Soda, Red Norland, Red Pontiac, Rooster, Russet Burbank, Russet Norkotah, Selma, Shepody, Sieglinde, Silverton Russet, Sirco, Snowden, Spunta, Up to date, Stobrawa, Superior, Villetta Rose, Vivaldi, Vitelotte, Yellow Finn or Yukon Gold.

In certain aspects, the sweet-potato is of any edible variety. For example, sweet-potato is of the variety Allgold, Apache, Beauregard, Brinkley White, Bunch Porto Rico, Carolina Ruby, Centennial, Cherokee, Continental Red, Cordner, Cordner's Red, Dianne, Garnet, Georgia Jet, Hayman, Hernandez, Jewell, Porto Rico or White Delight.

Sometimes, the Yam is of any edible variety. For example, Yam is of the variety Barbados, Imba, Moonshine, Taw, Yellow, Bitter Gashie, Hack, Luc, Mozzella, St. Vincent, White, Chinese, Hard, Negro, Sweet or Yampie.

In some exemplary embodiments, the fruit is a Musa plant. For example, the Musa plant is a banana or plantain. Sometimes, the banana is of any banana variety such as Mini (Chiquita), Monzano, Burro or Red banana.

In some exemplary embodiments, the edible plant which is ground to be incorporated in the mixture or suspension is an edible plant part. Sometimes the edible plant part is at least a part of a root, a stem, a leaf, a flower, a fruit, a bark or a seed. Occasionally, the edible plant part is also a root vegetable, root-like vegetable stem, modified plant stems or a plant bulb. In some exemplary embodiments, the edible plant part is the skin tissue of a tuber. At times, the tuber is a stem tuber or a root tuber. For example, the stem tuber is a potato. For example, the root tuber is sweet-potato, cassava (yuca) or yam.

In some instances, the potato is of any edible variety. For example, the potato is of the variety recited above. Sometimes, the sweet-potato is of any edible variety. For example, sweet-potato is of the variety recited above. At times, the Yam is of any edible variety. For example, Yam is of the variety recited above.

In some exemplary embodiments, the edible plant part is at least a part of the Musa plant. For example, the Musa plant is a banana or plantain. In certain aspects, the banana is of any edible variety such recited above. In some embodiments, the plant part of the Musa is a leaf, a flower, a seed, a trunk, a peel of the Musa fruit or any other edible part of the Musa plant.

In some exemplary embodiments, the edible plant part is at least a part of a fleshy plant. For example, the fleshy plant is any edible fleshy plant. For example, a fleshy plant is Aloe, Agave or a cactus plant. Sometimes, the edible plant part of Agave is the leaves, the stalks, the basal rosettes, the sap, or any other edible plant part. Aloe plant is Aloe barbadensis. At times, the edible plant part of the Aloe is the leaves or the seeds. Occasionally, the edible plant part of the Aloe leaves is the outer rind (skin) or the aloe latex. In certain embodiments, Cactus plant is any edible cactus, for example Opuntia, or Saguaro (Carnegiea gigantea). Other examples of edible fleshy cactus are of the genus Stenocereus, Hylocereus undatus, Echinocereus, Fero cactus, Mammillaria, Myrtillocactus, Pachycereus, Neowerdermannia vorwerkiior Peniocereus. Sometimes, Optunia is Optunia ficus-indica (also known as Indian fig opuntia, barbary fig, cactus pear, spineless cactus, and prickly pear). The edible plant part of Opuntia comprises the fruit, flower buds, flowers, pads or any other edible Optunia plant part.

In some exemplary embodiments the edible plant is (e.g., Arracacia xanthorrhiza (arracacha), Abelmoschus moschatus (bush carrot), Beta vulgaris (beet and mangelwurzel), Brassica spp. (rutabaga and turnip), Bunium persicum (black cumin), Burdock (Arctium, family Asteraceae), Carrot (Daucus carota subsp. sativus), Celeriac—(Apium graveolens rapaceum), Daikon—East Asian radish (Raphanus sativus var. longipinnatus), Dandelion—(Taraxacum) spp., Lepidium meyenii (maca), Microseris scapigera (yam daisy), Pachyrhizus spp. (jicama and ahipa), Parsnip (Pastinaca sativa), Petroselinum spp. (parsley root), Radish—(Raphanus sativus), Scorzonera hispanica (black salsify), Sium sisarum (skirret), Tragopogon spp. (salsify), Vigna lanceolata (bush potato), Amorphophallus galbra (Yellow lily yam), Conopodium majus (pignut or earthnut), Dioscorea opposita (nagaimo, Chinese yam, Korean yam), Hornstedtia scottiana (Native ginger), Ipomoea batatas (sweet potato), Ipomoea costata (desert yam), Manihot esculenta (cassava or yuca or manioc), Mirabilis extensa (mauka or chago), Psoralea esculenta (breadroot, tipsin, or prairie turnip), Smallanthus sonchifolius (yacon), Zamia pumila, (Florida arrowroot), Amorphophallus konjac (konjac), Colocasia esculenta (taro), Eleocharis dulcis (Chinese water chestnut), Ensete spp. (enset), Nelumbo nucifera, Nymphaea spp. (waterlily), Pteridium esculentum, Sagittaria spp. (arrowhead or wapatoo), Typha spp., Xanthosoma spp. (malanga, cocoyam, tannia, and other names), Curcuma longa (turmeric), Panax ginseng (ginseng), Arthropodium spp. (rengarenga, vanilla lily, and others), Canna spp. (canna), Cordyline fruticosa (ti), Maranta arundinacea (arrowroot), Nelumbo nucifera (lotus root), Typha spp. (cattail or bulrush), Zingiber officinale (ginger, galangal), Apios americana (hog potato or groundnut), Cyperus esculentus (tigernut or chufa), Dioscorea spp. (yams, ube), Helianthus tuberosus (Jerusalem artichoke or sunchoke), Hemerocallis spp. (daylily), Lathyrus tuberosus (earthnut pea), Oxalis tuberosa (oca or New Zealand yam), Plectranthus edulis and P. esculentus (kembili, dazo, and others), Solanum tuberosum (potato), Stachys affinis (Chinese artichoke or crosne), Tropaeolum tuberosum (mashua or añu), Ullucus tuberosus (ulluco), Allium spp. (garlic, onion, shallot, et cetera), Camassia quamash (quamash), Cyperus bulbosus (bush onion), Caladenia, Cryptostylis, Cymbidium canaliculatum, Diuris, Dipodium, Erythronium spp. (katakuri), Foeniculum vulgare (fennel), Geodorum, Glossodia, Lilium spp. (lilies), Lypernathus, Microtis, Prasophyllum, Pterostylis, Tacca leontopetaloides, Thelymitra). In some exemplary embodiments the edible plant is an edible cactus selected from the list consisting of Acanthocalycium, Acanthocereus, Acharagma, Ancistrocactus, Ariocarpus, Armatocereus, Arrojadoa, Arthrocereus, Astrophytum, Austrocactus, Austrocylindropuntia, Aztekium, Bergerocactus, Blossfeldia, Brachycereus, Brasilicereus, Brasiliopuntia, Browningia, Calymmanthium, Carnegiea, Cephalocereus, Cereus, Cintia, Cipocereus, Cleistocactus, Cochemiea, Coleocephalocereus, Consolea, Copiapoa, Corryocactus, Corynopuntia, Coryphantha, Cumulopuntia, Cylindropuntia, Dendrocereus, Denmoza, Discocactus, Disocactus, Echinocactus, Echinocereus, Echinomastus, Echinopsis, Epiphyllum, Epithelantha, Eriosyce, Escobaria, Escontria, Espostoa, Espostoopsis, Eulychnia, Facheiroa, Ferocactus, Frailea, Geohintonia, Grusonia, Gymnocalycium, Haageocereus, Harrisia, Hatiora, Hylocereus, Isolatocereus, Jasminocereus, Lasiocereus, Leocereus, Lepismium, Leptocereus, Leuchtenbergia, Lophophora, Maihuenia, Maihueniopsis, Mammillaria, Mammilloydia, Matucana, Melocactus, Micranthocereus, Micropuntia, Mila, Miqueliopuntia, Myrtillocactus, Neobuxbaumia, Neolloydia, Neoraimondia, Neowerdermannia, Obregonia, Opuntia, Oreocereus, Oroya, Ortegocactus, Pachycereus, Parodia, Pediocactus, Pelecyphora, Peniocereus, Pereskia, Pereskiopsis, Pierrebraunia, Pilosocereus, Polaskia, Praecereus, Pseudoacanthocereus, Pseudorhipsalis, Pterocactus, Pygmaeocereus, Quiabentia, Rauhocereus, Rebutia, Rhipsalis, Samaipaticereus, Schlumbergera, Sclerocactus, Selenicereus, Stenocactus, Stenocereus, Stephanocereus, Stetsonia, Strombocactus, Sulcorebutia, Tacinga, Tephrocactus, Thelocactus, Tunilla, Turbinicarpus, Uebelmannia, Weberbauerocereus, Weberocereus, xPacherocactus, Yavia and Yungasocereus. The edible cacti plant part comprises skin, root, or fruit. In some embodiments the edible periderm or skin of edible part of the plant, flower, root or fruit of the succulent selected from the group consisting of Alismatales, Apiales, Asparagales, Asterales, Caryophyllales, ommelinatest, Cornales, Cucurbitales, Diascoreales, Ericales, Fabales, Gentianales, Geraniales, Lamiales, Malpighiales, Malvales, Myrtales, Oxalidales, Piperales, Poales, Ranunculales, Rosales, Santalales, Sapindales, Saxifragales, Solanales, Vitales, Zygophyllales, Agavoideae, Cactaceae, Crassulaceae, Aizoaceae, Apocynaceae, Didiereaceae, Euphorbiaceae, Xanthorrhoeaceae and Portulacaceae.

In some exemplary embodiments, the mixture or suspension also comprises cellulose. Sometimes, the cellulose is cellulose, hemicellulose, modified cellulose, modified hemicellulose or any combination thereof. In some exemplary embodiments the cellulose is microcellulose. The hemicellulose is xylooligosaccharides, glucoronoxylan, arabinoxylan, glucomannan, xyloglucan or any combination thereof. The modified cellulose is methyl cellulose, ethyl cellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose or any combination thereof.

In some exemplary embodiments, the mixture or suspension also comprises a monosaccharide, a disaccharide or an oligosaccharide. Sometimes, an oligosaccharide is any saccharide comprising three or more covalently bound sugar units.

In some examples, monosaccharides comprise galactose, fructose, glucose, sorbose, agatose, tagatose or xylose. In certain aspects, oligosaccharide is sucrose, lactose, lactulose, maltose, isomaltose, maltulose, saccharose, trehalose, or any combination thereof. In some exemplary embodiments the mixture or suspension comprises high fructose corn syrup.

In some examples, the mixture comprises polysaccharide. Examples of a polysaccharide are agar, alginates, carrageenans, furcellaran, gum arabic, gum ghatti, gum tragacanth, karaya gum, guaran gum, locust bean gum, tamarind flour, arabinogalactan, pectin, starch, modified starches, dextrins, cellulose, cellulose derivatives, hemicelluloses, xanthan gum, scleroglucan, dextran, polyvinyl pyrrolidone, or any combination thereof. In some exemplary embodiments the mixture or suspension comprises polysorbates, mono- or di-glycerides, sterols, stanols, phytosterols, polysaccharide like sugars, or any combination thereof. In some instances sugars are derived from sugarcane, beet, honey, agave, glucose, fructose, galactose, sucrose, maltose, lactose. In some exemplary embodiments the mixture or suspension comprises natural sugar substitutes such as hydrogenated starch hydrolysates such as corn syrups or maltodextrins or dextrins, inulin, glycerol, erythritol, curculin, brazzein, maltitol, isomalt, lactitol, mabinlin, malto-oligosaccharides, mannitol, miraculin, monatin, monellin, osladin, pentadin, pentadin, sorbitol, stevia, tagatose, thaumatin, xylito, Luo Han Guo, or any combination thereof. In some exemplary embodiments, the mixture or suspension comprises an artificial sugar substitutes such as ACK, alitame, aspartame, cyclamate, salt of aspartame acesulfame, dulcin, glucin, neohesperidin dihydrochalcone, neotame, saccharin, sucralose, P4000, or any combination thereof.

In some exemplary embodiments, the mixture or suspension also comprises a beneficial agent. Occasionally, the beneficial agent is a micronutrient, a probiotic, a prebiotics or a vitamin. Sometimes, the beneficial agent is fat soluble or water soluble. In some instances, the fat soluble enhancing agent is retinol (vitamin A), calciferol (vitamin D), tocopherol (vitamin E), phytomenadione (vitamin K1), or any combination thereof. Sometimes, the water soluble enhancing agent is thiamine (vitamin B1), riboflavin (vitamin B2), pyridoxine (vitamin B6), nicotinamide (niacin), pantothenic acid, biotin, folic acid, cyanocobalamin (vitamin B12), ascorbic acid (vitamin C), polyunsaturated fatty acids (PUFA), an any combination thereof. In some embodiments, the beneficial agent is a capsaicinoid. In some exemplary embodiments, the beneficial agent is coenzyme A, coenzyme Q, salts, stanols, sterols, phytosterols, lycopene, mono-and/or polyunsaturated fats like Omega-3 (ALA, EPA, DHA), Omega-6 (GLA, DGLA, AA), saturated fats, arachiinodic, linoleic, Phytonutrients such as Natural monophenoils (apiole, carnosol, carvacrol, dillapiole) Flavonoids (quercetin, gingerole, kaempferol, myricetin, rutin, isorhamnetin) Flavanones (hesperidin, naringerin, silybin, eriodictyol) Flavones (apigenin, tangeritin, luteolin), flavan-3-ols (cathechins, gallocatechin, epicatechin, epigalocatechin, epigallocatechin gallate, epichatechin 3-gallate, theaflavin, theaflavion-3-gallate, theaflavin-3′-gallate, theaflavin-3-3′-digallate, thearubigins), anthocyaninns (pelargonidin, peonidin, cyaniding, delphinidin, malvidin, petudinin) Isoflavones (daidzein, genistein, glycitein) Dihydroflavonols, chalconoids, coumestans, phenolic acids (ellagic acid, gallic acid, salicylic acid, tannic acid, vanillin, capsaicin, curcumin) Hydroxycinnamic acids (caffeic acid, chlorogenic acid, cinnamic acid, ferulic acid, cumarin) lignans (silymarin, matairesinol, secoisolariciresinol, pinoresinol, lariciresinol) tyrosol esters (tyrosol, hydroxytyrosol, oleochanthal, oleuropein) stillbenoids (resveratol, pterostilbene, piceatannol), alkylresorcinols, carotenoids (alpha- carotene, beta-carotene, gamma-carotene, delta-carotene, lycopene, neuroperene, phytofluene, phytoene), Xantophylls (canthaxanthin, cryptoxanthin, zeaxanthin, astaxanthin, lutein, rubixanthin), Monoterpenes (limonene, perillyl alcohol), Saponins, phytosterols (campesterol, sitosterol, gamma-sytosterol, stigmasterols, etc.) , tri-terpenoids (oleanolic acid, ursolic acid, betulinic acid, moronic acid), Betalains (betacyanins like betanin, isobetanin, probetanin, and beobetanin), betaxanthins like indicaxanthin and vulgaxanthin, Organosulfides (dithiolthiones like sulphoraphane), polysilfides (allylmethyltrisulfide), Sulfides (diallylsulfides), Indole and glucosinolates (indole-3-carninol, sulphoraphane, sinigrin, allicin, alliin, allylisothiocyanate, piperine, syn-propabethial-S-Oxide), or combinations thereof.

In some exemplary embodiments, the mixture or suspension also comprises a binding agent. The binding agent is starch, pectin or gelatin. In some embodiments, the starch is derived from a plant such as a potato, corn, rice, wheat, barley, oat, tapioca, arrow root, guar gum, locust bean, arracacha, buckwheat, kudzu, oca, sorghum, sweet potato, taro, yam, banana, cassava (Yuca), sago, fava, lentil, pea, any of the abovementioned cereals, or any combination thereof. In some examples, the binding agent is also a gelation agent. Sometimes, the gelation agent is any edible gelation agent such as gelatin, pectin, alginate, agar, carrageenan, hydrocolloids, phycocolloids, alginin, guar gum, locust bean gum, xanthan gum, collagen, egg whites, furcellaran, sodium pyrophosphate or any combination thereof.

In some exemplary embodiments, the mixture or suspension is also comprise a spice, a flavor, a food enhancer, an aroma, a color, an antioxidant agent, an anti-caking agent, anti-microbial agent, a lipid, an emulsifier, milk, a protein, an egg.

In some embodiments, the emulsifier is egg yolk, lecithin, mustard, soy lecithin, Diacetyl Tartaric (Acid) Ester of Monoglyceride, Sodium stearoyl lactylate, or any combination thereof.

In some embodiments, the protein is a peptide, protein, amino-acid or any combination thereof. Sometimes, the protein is from a vegetable source, animal source, bacteria source, yeast source, synthetic source or any combination thereof. Occasionally, the amino acid is histidine, isoleucine, leucine, lysine, methionine, phenylalanine, threonine, tryptophan, valine, alanine, arginine, asparagines, aspartic acid, cysteine, glutamic acid, glutamine, glycine, ornithine, proline, selenocysteine, serine, taurine, tyrosine, gamma amino-butyric acid, hydroxyproline, selenomethionine, lanthionine, 2-aminoisobutyric acid, dehydro-alanine, ornithine, citrulline, beta-alanine, or any combination thereof.

In some embodiments, the flavor is an agent imparting any of the basic tastes such as sweetness, sourness, saltiness, bitterness, umami, or any combination thereof. Occasionally, the Flavor or food enhancer is monosodium glutamate, maltol, 5′-mononucleotides, such as inosine, or any combination thereof.

In some exemplary embodiments, the aroma is an agent imparting an odor, fragrance or smell with the basic known fragrance characteristics or any combination thereof. For example, basic fragrance characteristics comprise sweet, pungent, acrid, fragrant, warm, dry, sour, or any combination thereof. Examples for food aroma agents comprise carbonyl compounds, pyranones, furanones, thiols, thioethers, di- and trisulfides, thiophenes, thiazoles, pyrroles, pyridines, pyrazines, phenols, alcohols, hydrocarbons, esters, lactones, terpenes, volatile sulfur compounds, or any combination thereof. In some embodiments, the flavor is derived from natural fruit juice, natural fruit juice concentrate, or any combination thereof.

In some exemplary embodiments, the color is any natural or artificial food coloring. Natural food coloring is Annatto (E160b), Betanin (E162), Butterfly pea (Clitoria ternatea), Caramel coloring (E150), Chlorophyllin (E140), Elderberry juice, Lycopene (E160d), Cochineal (E120), Pandan (Pandanus amaryllifolius), Paprika (E160c), Turmeric (curcuminoids, E100), Saffron (carotenoids, E160a), beet color, berry color, red cabbage color. Berry color derives from strawberry, blueberry, currant, raspberry, mulberry, grape, gooseberry, wolfberry (goji-berry) and any combination thereof. Artificial food coloring is FD&C Blue No. 1—Brilliant Blue FCF, E133 (blue shade), FD&C Blue No. 2—Indigotine, E132 (indigo shade), FD&C Green No. 3—Fast Green FCF, E143 (turquoise shade), FD&C Red No. 3—Erythrosine, E127 (pink shade, commonly used in glace cherries), FD&C Red No. 40—Allura Red AC, E129 (red shade), FD&C Yellow No. 5—Tartrazine, E102 (yellow shade), FD&C Yellow No. 6—Sunset Yellow FCF, E110 (orange shade), any other governmentally authorized food coloring, or any combination thereof.

In some embodiments, the anti-caking agent is E341 tricalcium phosphate, E460(ii) powdered cellulose, E470b magnesium stearate, E500 sodium bicarbonate, E535 sodium ferrocyanide, E536 potassium ferrocyanide, E538 calcium ferrocyanide, E542 bone phosphate, E550 sodium silicate, E551 silicon dioxide, E552 calcium silicate, E553a magnesium trisilicate, E553b talcum powder, E554 sodium aluminosilicate, E555 potassium aluminium silicate, E556 calcium aluminosilicate, E558 bentonite, E559 aluminium silicate, E570 stearic acid or E900 polydimethylsiloxane.

In some exemplary embodiments, the anti-microbial agent comprises an anti-microbial essential oil, benzoic acid, PHB esters, sorbic acid, propionic acid, acetic acid, sodium sulfite and sodium metabisulfite, diethyl pyrocarbonate, ethylene oxide, propylene oxide, nitrite, nitrate, antibiotics, diphenyl, o-phenylphenol, thiabendazole or any combination thereof. Sometimes, the anti-microbial (antimicrobial) essential oil is Cinnamon oil, Clove oil, Eucalyptus oil, Garlic, Oregano oil, Lavender oil, Leleshwa oil, Lemon oil, Lemon myrtle oil, Mint oil, Neem oil, Nigella sativa (black cumin) oil, Onion oil, Peppermint oil, Sandalwood oil, Ironwort, Tea tree oil, Thyme oil, or any combination thereof.

In some exemplary embodiments, the antioxidant (anti-oxydant) agent is vitamin E, vitamin E complex, tocopherols, 2,6-di-tert-butyl-p-cresol (BHT), tert-butyl-4-hydroxyanisole (BHA), propylgallate, octylgallate, dodecylgallate, ethoxyquin, ascorbyl palmitate, ascorbic acid (Vitamin C), alpha caroten, astaxantin, beta carotene (vitamin A), canthaxantin, luthein, lycophene, zeaxanthin, curcumin, Flavonolignans, xanthones, Eugenol, chicoric acid, chlorogenic acid, cinnamic acid, ellagic acid, elagitannins, gallic acid, gallotannins, rosmarinic acid, salicylic acid, Flavonoid and any combination thereof. In some aspects, a flavonoid is a Favone, Flavonol, Flavanols, Flavanones, Isoflavone phytoestrogens, Stilbenoids, Anthocyanins, Pterostilbene or any combination thereof. Flavones is Apigenin, Luteolin, Tangeritin or any combination thereof. Flavonolsis Isorhamnetin, Kaempferol, Myricetin, Proanthocyanidins (or condensed tannins), Quercetin, rutin, or any combination thereof. In some examples, Flavanon is Eriodictyol, Hesperetin (metabolizes to hesperidin), Naringenin (metabolized from naringin) or any combination thereof. Sometimes, Flavanol comprises Flavanol polymers. Flanvanol is Catechin, gallocatechin and their corresponding gallate esters, Epicatechin, epigallocatechin and their corresponding gallate esters, Theaflavin its gallate esters, Thearubigin, or any combination thereof. In some examples, Isoflavone phytoestrogens comprise any members of the Fabaceae family Daidzein, Genistein, Glycitein, or any combination thereof. In some instances, Stilbenoids is Resveratrolm, Pterostilbene (methoxylated analogue of resveratrol), or any combination thereof. In some instances, Anthocyanins is Cyanidin, Delphinidin, Malvidin, Pelargonidin, Peonidin, Petunidin, or any combination thereof.

In some exemplary embodiments, the lipid is an oil such as an animal or vegetable oil as exemplified above. Sometimes the lipid is unsaturated fatty acids, mono- and diacyl glycerols triacyl glycerols, phospholipids, glycolipids, phosphatidyl derivatives, glycerolglycolipids, sphingolipids, lipoproteins, diol lipids, waxes, cutin, or any combination thereof. Occasionally, the oil is any ingestible oil such as any vegetable oil or any animal oil. For example, vegetable oil comprises olive oil, palm oil, soybean oil, canola oil (rapeseed oil), avocado oil, coconut oil, pumpkin seed oil, corn oil, sunflower oil, safflower oil, peanut oil, grape seed oil, sesame oil, agan oil or rice bran oil. In some embodiments, animal oil comprises butter, ghee or lard. In some exemplary embodiments, the oil content in the mixture or suspension is at least 0.01%, 0.05%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10%, 15%, 20%, 25%, or 30% weight by weight of the total mixture of suspension. In some exemplary embodiments, the oil content in the mixture or suspension is at most 0.01%, 0.05%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9%, 10%, 15%, 20%, 25%, or 30% weight by weight of the total mixture of suspension. In some embodiments the mixture or suspension does not comprise a measurable amount of oil. In some embodiments the mixture or suspension does not comprise a measurable amount of unsaturated fatty acid moieties. In some embodiments the mixture or suspension does not comprise a measurable amount of vegetable oil or animal oil.

In some exemplary embodiments, the texture of the ingestible item comprises crispness, crunchiness, crumbliness or brittleness. Without wishing to be bound to a theory, these textures is refer to the tendency of a material to fracture, crumble, crack, shatter or fail upon the application of a force or impact without significant deformation such as permanent or plastic deformation. Such materials typically display a high degree of hardness and low degree of cohesiveness, where there hardness refers to the maximum amount of energy the coating is absorb before fracturing. In some embodiments, the coating is characterized by the factorability of the coating, fracture strength, fracture distance, work of failure, breaking strength, breaking energy and acoustics. In some instances, the desired coating requires a peak force to break the coating. Sometimes, such peak force is at least 10 N/g, 11 N/g, 12 N/g, 13 N/g, 14 N/g, 15 N/g, 16 N/g, 17 N/g, 18 N/g, 19 N/g, 20 N/g , 21 N/g, 22 N/g, 23 N/g, 24 N/g, 25 N/g, 26 N/g, 27 N/g, 28 N/g, 29 N/g, 30 N/g, 31 N/g, 32 N/g, 33 N/g, 34 N/g, 35 N/g, 36 N/g, 37 N/g, 38 N/g, 39 N/g, 40 N/g, 41 N/g, 42 N/g, 43 N/g, 44 N/g, 45 N/g, 46 N/g, 47 N/g, 48 N/g, 49 N/g, 50 N/g, 51 N/g, 52 N/g, 53 N/g, 54 N/g, 55 N/g, 56 N/g, 57 N/g, 58 N/g, 59 N/g, 60 N/g, 65 N/g, 70 N/g, 75 N/g, 80 N/g, 85 N/g, 90 N/g or at most 95 Newtons per gram (N/g). In some exemplary embodiments, the desired coating requires a peak force to break the coating. In some occasions the peak force is at most 11 N/g, 12 N/g, 13 N/g, 14 N/g, 15 N/g, 16 N/g, 17 N/g, 18 N/g, 19 N/g, 20 N/g , 21 N/g, 22 N/g, 23 N/g, 24 N/g, 25 N/g, 26 N/g, 27 N/g, 28 N/g, 29 N/g, 30 N/g, 31 N/g, 32 N/g, 33 N/g, 34 N/g, 35 N/g, 36 N/g, 37 N/g, 38 N/g, 39 N/g, 40 N/g, 41 N/g, 42 N/g, 43 N/g, 44 N/g, 45 N/g, 46 N/g, 47 N/g, 48 N/g, 49 N/g, 50 N/g, 51 N/g, 52 N/g, 53 N/g, 54 N/g, 55 N/g, 56 N/g, 57 N/g, 58 N/g, 59 N/g, 60 N/g, 65 N/g, 70 N/g, 75 N/g, 80 N/g, 85 N/g, 90 N/g or at most 95 Newtons per gram (N/g).

In some exemplary embodiments, the coating texture is determined by its level of humidity (i.e. its moisture content). In some embodiments, the desired crispy coating contains at most 1%, 2%, 3%, 4%, 5%, 6%, 7%, 8%, 9%, 10%, 11%, 12%, 13%, 14%, 15%, 16%, 17%, 18%, 19%, 20% , 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 65%, 70%, 75%, 80%, 85%, 90% or at most 95% weight by weight moisture as compared to the total weight of the coated ingestible item. In some examples, the desired crispy coating is have a moisture comprises at most 1%, 2%, 3%, 4%, 5%, 6%, 7%, 8%, 9%, 10%, 11%, 12%, 13%, 14%, 15%, 16%, 17%, 18%, 19%, 20% , 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, or at most 55% weight by weight moisture as compared to the total weight of the coated ingestible item.

In some instances, the texture of the ingestible item is analyzed using an acoustic detector such as an Acoustic Envelope Detector. Sometimes, the acoustic detector detects the sound produced during an initiated fracture. Without wishing to be bound to a theory, it is believed that the acoustic signal is as a result of a material failure such as a crack, break or snap. In some exemplary embodiments, the ultrasonic velocity is correlated with sensory crispiness. Sometimes the acoustic detector detects the ultrasonic velocity. In some embodiments, the desired texture has an ultrasonic velocity of at least 100 m/s, 101 m/s, 102 m/s, 103 m/s, 104 m/s, 105 m/s, 106 m/s, 107 m/s, 108 m/s, 109 m/s, 200 m/s, 201 m/s, 202 m/s, 203 m/s, 204 m/s, 205 m/s, 206 m/s, 207 m/s, 208 m/s, 209 m/s, 300 m/s, 301 m/s, 302 m/s, 303 m/s, 304 m/s, 305 m/s, 306 m/s, 307 m/s, 308 m/s, 309 m/s, 400 m/s, 401 m/s, 402 m/s, 403 m/s, 404 m/s, 405 m/s, 406 m/s, 407 m/s, 408 m/s, 409 m/s, 500 m/s, 501 m/s, 502 m/s, 503 m/s, 504 m/s, 505 m/s, 506 m/s, 507 m/s, 508 m/s, 509 m/s, 600 m/s, 601 m/s, 602 m/s, 603 m/s, 604 m/s, 605 m/s, 606 m/s, 607 m/s, 608 m/s, 609 m/s, 700 m/s, 701 m/s, 702 m/s, 703 m/s, 704 m/s, 705 m/s, 706 m/s, 707 m/s, 708 m/s, 709 m/s, 800 m/s, 801 m/s, 802 m/s, 803 m/s, 804 m/s, 805 m/s, 806 m/s, 807 m/s, 808 m/s, 809 m/s, or at least 900 meters per second (m/s),In some examples, the desired texture is have an ultrasonic velocity of at most 101 m/s, 102 m/s, 103 m/s, 104 m/s, 105 m/s, 106 m/s, 107 m/s, 108 m/s, 109 m/s, 200 m/s, 201 m/s, 202 m/s, 203 m/s, 204 m/s, 205 m/s, 206 m/s, 207 m/s, 208 m/s, 209 m/s, 300 m/s, 301 m/s, 302 m/s, 303 m/s, 304 m/s, 305 m/s, 306 m/s, 307 m/s, 308 m/s, 309 m/s, 400 m/s, 401 m/s, 402 m/s, 403 m/s, 404 m/s, 405 m/s, 406 m/s, 407 m/s, 408 m/s, 409 m/s, 500 m/s, 501 m/s, 502 m/s, 503 m/s, 504 m/s, 505 m/s, 506 m/s, 507 m/s, 508 m/s, 509 m/s, 600 m/s, 601 m/s, 602 m/s, 603 m/s, 604 m/s, 605 m/s, 606 m/s, 607 m/s, 608 m/s, 609 m/s, 700 m/s, 701 m/s, 702 m/s, 703 m/s, 704 m/s, 705 m/s, 706 m/s, 707 m/s, 708 m/s, 709 m/s, 800 m/s, 801 m/s, 802 m/s, 803 m/s, 804 m/s, 805 m/s, 806 m/s, 807 m/s, 808 m/s, 809 m/s, or at most 900 meters per second (m/s).

Without wishing to be bound to a theory, it is generally believed that the acoustic detector detects the acoustic transmission loss. In some embodiments, the desired texture is have a transmission loss of at least 0.20 dB/mm, 0.21 dB/mm, 0.22 dB/mm, 0.23 dB/mm, 0.24 dB/mm, 0.25 dB/mm, 0.26 dB/mm, 0.27 dB/mm, 0.28 dB/mm, 0.29 dB/mm, 0.30 dB/mm, 0.31 dB/mm, 0.32 dB/mm, 0.33 dB/mm, 0.34 dB/mm, 0.35 dB/mm, 0.36 dB/mm, 0.37 dB/mm, 0.38 dB/mm, 0.39 dB/mm, 0.40 dB/mm, 0.41 dB/mm, 0.42 dB/mm, 0.43 dB/mm, 0.44 dB/mm, 0.45 dB/mm, 0.46 dB/mm, 0.47 dB/mm, 0.48 dB/mm, 0.49 dB/mm, 0.50 dB/mm, 0.51 dB/mm, 0.52 dB/mm, 0.53 dB/mm, 0.54 dB/mm, 0.55 dB/mm, 0.56 dB/mm, 0.57 dB/mm, 0.58 dB/mm, 0.59 dB/mm, 0.60 dB/mm, 0.61 dB/mm, 0.62 dB/mm, 0.63 dB/mm, 0.64 dB/mm, 0.65 dB/mm, 0.66 dB/mm, 0.67 dB/mm, 0.68 dB/mm, 0.69 dB/mm, 0.70 dB/mm, 0.71 dB/mm, 0.72 dB/mm, 0.77 dB/mm, 0.74 dB/mm, 0.75 dB/mm, 0.76 dB/mm, 0.77 dB/mm, 0.78 dB/mm, 0.79 dB/mm, 0.80 dB/mm, 0.81 dB/mm, 0.82 dB/mm, 0.88 dB/mm, 0.84 dB/mm, 0.85 dB/mm, 0.86 dB/mm, 0.87 dB/mm, 0.88 dB/mm, 0.89 dB/mm, 0.90 dB/mm, 0.91 dB/mm, 0.92 dB/mm, 0.99 dB/mm, 0.94 dB/mm, 0.95 dB/mm, 0.96 dB/mm, 0.97 dB/mm, 0.98 dB/mm, 0.99 dB/mm, 1.00 dB/mm, 1.01 dB/mm, 1.02 dB/mm, 1.03 dB/mm, 1.04 dB/mm, 1.05 dB/mm, 1.06 dB/mm, 1.07 dB/mm, 1.08 dB/mm, 1.09 dB/mm, 1.10 dB/mm, 1.11 dB/mm, 1.12 dB/mm, 1.13 dB/mm, 1.14 dB/mm, 1.15 dB/mm, 1.16 dB/mm, 1.17 dB/mm, 1.18 dB/mm, 1.19 dB/mm, 1.20 dB/mm, 1.21 dB/mm, 1.22 dB/mm, 1.23 dB/mm, 1.24 dB/mm, 1.25 dB/mm, 1.26 dB/mm, 1.27 dB/mm, 1.28 dB/mm, 1.29 dB/mm, 1.30 dB/mm, 1.31 dB/mm, 1.32 dB/mm, 1.33 dB/mm, 1.34 dB/mm, 1.35 dB/mm, 1.36 dB/mm, 1.37 dB/mm, 1.38 dB/mm, 1.39 dB/mm or at least 1.40 dB/mm. In some exemplary embodiments, the desired texture is have a transmission loss of at most 0.20 dB/mm, 0.21 dB/mm, 0.22 dB/mm, 0.23 dB/mm, 0.24 dB/mm, 0.25 dB/mm, 0.26 dB/mm, 0.27 dB/mm, 0.28 dB/mm, 0.29 dB/mm, 0.30 dB/mm, 0.31 dB/mm, 0.32 dB/mm, 0.33 dB/mm, 0.34 dB/mm, 0.35 dB/mm, 0.36 dB/mm, 0.37 dB/mm, 0.38 dB/mm, 0.39 dB/mm, 0.40 dB/mm, 0.41 dB/mm, 0.42 dB/mm, 0.43 dB/mm, 0.44 dB/mm, 0.45 dB/mm, 0.46 dB/mm, 0.47 dB/mm, 0.48 dB/mm, 0.49 dB/mm, 0.50 dB/mm, 0.51 dB/mm, 0.52 dB/mm, 0.53 dB/mm, 0.54 dB/mm, 0.55 dB/mm, 0.56 dB/mm, 0.57 dB/mm, 0.58 dB/mm, 0.59 dB/mm, 0.60 dB/mm, 0.61 dB/mm, 0.62 dB/mm, 0.63 dB/mm, 0.64 dB/mm, 0.65 dB/mm, 0.66 dB/mm, 0.67 dB/mm, 0.68 dB/mm, 0.69 dB/mm, 0.70 dB/mm, 0.71 dB/mm, 0.72 dB/mm, 0.77 dB/mm, 0.74 dB/mm, 0.75 dB/mm, 0.76 dB/mm, 0.77 dB/mm, 0.78 dB/mm, 0.79 dB/mm, 0.80 dB/mm, 0.81 dB/mm, 0.82 dB/mm, 0.88 dB/mm, 0.84 dB/mm, 0.85 dB/mm, 0.86 dB/mm, 0.87 dB/mm, 0.88 dB/mm, 0.89 dB/mm, 0.90 dB/mm, 0.91 dB/mm, 0.92 dB/mm, 0.99 dB/mm, 0.94 dB/mm, 0.95 dB/mm, 0.96 dB/mm, 0.97 dB/mm, 0.98 dB/mm, 0.99 dB/mm, 1.00 dB/mm, 1.01 dB/mm, 1.02 dB/mm, 1.03 dB/mm, 1.04 dB/mm, 1.05 dB/mm, 1.06 dB/mm, 1.07 dB/mm, 1.08 dB/mm, 1.09 dB/mm, 1.10 dB/mm, 1.11 dB/mm, 1.12 dB/mm, 1.13 dB/mm, 1.14 dB/mm, 1.15 dB/mm, 1.16 dB/mm, 1.17 dB/mm, 1.18 dB/mm, 1.19 dB/mm, 1.20 dB/mm, 1.21 dB/mm, 1.22 dB/mm, 1.23 dB/mm, 1.24 dB/mm, 1.25 dB/mm, 1.26 dB/mm, 1.27 dB/mm, 1.28 dB/mm, 1.29 dB/mm, 1.30 dB/mm, 1.31 dB/mm, 1.32 dB/mm, 1.33 dB/mm, 1.34 dB/mm, 1.35 dB/mm, 1.36 dB/mm, 1.37 dB/mm, 1.38 dB/mm, 1.39 dB/mm or at most 1.40 dB/mm.

Without wishing to be bound to a theory, it is believed that the acoustic wave of the breaking crispy texture of the coating is characterized by sharp triangular curves displaying a detectable break point.

In some embodiments, the hardness of the textured ingestible item is measured using a scratch test or indentation hardness test. Without wishing to be bound to a theory, it is believed that scratch test is measure the force necessary to cut through the coating of the textured ingestible item. In some instances, the indentation hardness test is measure the resistance of the coating, to deformation due to a constant compression load from a sharp object.

In some examples, the crispiness of the textured ingestible item is measured using a Stevens Texture Analyzer, texture analyzer, Q test or Instron test. Examples for texture analyzers include TA.XTPlus, TA.HDPlus, and TA.XTExpress Texture Analyzers. The Instron test comprises compressed and deformation tests at various loads. An example for a Stevens Texture Analyzer is the one manufacture by Brookfield Engineering. An example for a Q test is the one manufacture by Stable Micro Systems Ltd.

In some exemplary embodiments, the mixture or suspension is further comprise collagen, hyaluronic acid, animal or human body fluids such as synovial fluid, blood, blood serum, plasma, urine, bone marrow, or any combination thereof.

In some embodiments, the mixture comprises protein inhibitors. In some examples, protein inhibitors are oxalic acid, phytic acid, tartaric acid or anacardic acid.

In some instances, the mixture comprises caffeine, fluoride, folic acid (or folate), dietary fiber, proteins, modified proteins (such as, for example, protein hydrolysates, isolates), or any combination thereof.

In some examples, the mixture or suspension comprises an ingestible alga, fungi, yeast, mold, bacteria, lychen or any of their ingestible byproducts.

In some embodiments, the algae is an edible seaweed, Agar, Alaria esculenta, Arame, Callophyllis variegata, Carrageenan, Caulerpa lentillifera, Chlorella, Chondrus crispus, Cladosiphon okamuranus, Durvillaea antarctica, Ecklonia cava, Eucheuma, Fucus spiralis, Fucus vesiculosus, Gelidiaceae, Gracilaria, Hijiki, Himanthalia elongata, Kaipen, Kombu, Laminaria digitata, Laver (seaweed), Mastocarpus stellatus, Nereocystis, Nori, Ogonori, Palmaria palmata, Pelvetia, Porphyra, Postelsia, Saccharina japonica, Saccharina latissima, Sargassum, Sea lettuce, Seaweed, Spirulina (dietary supplement), Ulva intestinalis, Wakame, or any combination thereof.

In some examples, the mold is Fusarium venenatum, Geotrichum candidum, Neurospora sitophila, Penicillium spp., Rhizomucor miehei, Rhizopus oligosporus, Penicillium notatum, Penicillium chrysogenum, Penicillium rubens or any combination thereof.

In some examples, the fungi is Boletus edulis, Cantharellus cibarius, Cantharellus tubaeformis, Clitocybe nuda, Cortinarius caperatus, Craterellus cornucopioides, Grifola frondosa, Gyromitra esculenta (parboiled), Hericium erinaceus, Hydnum repandum, Lactarius deliciosus, Morchella conica (var. deliciosa), Morchella esculenta (var. rotunda),Tricholoma matsutake, Tuber borchii, Tuber brumale, Tuber indicum, Tuber macrosporum, Tuber mesentericum, Bagnoli truffle, Tuber uncinatum, Lactarius salmonicolor, Amanita caesarea, Armillaria mellea, Boletus badius, Chroogomphus rutilus, Calvatia gigantea, Calocybe gambosa, Clavariaceae, Clavulinaceae, Coprinus comatus, Corn smut, Cortinarius variicolor, Fistulina hepatica, Hygrophorus chrysodon, Auricularia auricula-judae, Lactarius salmonicolor, Lactarius subdulcis, Lactarius volemus, Laetiporus sulphureus, Leccinum aurantiacum, Leccinum scabrum, Lepiota procera, Macrolepiota procera, Polyporus squamosus, Polyporus mylittae, Ramariaceae species, Rhizopogon luteolus, Russula, Sparassis crispa, Suillus bovinus, Suillus granulatus, Suillus luteus, Suillus tomentosus, Tricholoma terreum, or any combination thereof.

In some exemplary embodiments, the bacteria is Bacillus natto, Bifidobacterium adolescentis, Bifidobacterium animalis, Bifidobacterium breve, Bifidobacterium bifidum, Bifidobacterium infantis, Bifidobacterium lactis, Bifidobacterium longum, Enterococcus faecium, Enterococcus faecalis, Escherichia coli, Lactobacillus acidophilus, Lactobacillus brevis, Lactobacillus casei (e.g. immunitas, shirota, etc.), Lactobacillus delbrueckii, Lactobacillus fermentum, Lactobacillus gas seri, Lactobacillus helveticus, Lactobacillus johnsonii, Lactobacillus lactis, Lactobacillus paracasei, Lactobacillus plantarum, Lactobacillus reuteri, Lactobacillus rhamnosus, Lactobacillus sakei, Lactobacillus salivarius, Lactococcus lactis, Lactococcus cremoris, Leuconostoc mesenteroides, Leuconostoc lactis, Pediococcus acidilactici, Pediococcus cerevisiae, Pediococcus pentosaceus, Propionibacterium freudenreichii, Propionibacterium shermanii, Streptococcus salivarius, or any combination thereof. Edible lychen is raria islandica, Cladonia rangiferina, Parmelia perlata, Umbilicaria, Probiotic bacteria such as Bifidobacterium, Propionibacterium, Enterococcus, Streptococcus, Lactococcus, Bacillus, Pediococcus, Micrococcus, Leuconostoc, Weissella, Oenococcus, Lactobacillus, or any combination thereof, and further combined with any type of the aforementioned bacteria species.

In some exemplary embodiments, the yeast is any edible yeast such as baker's yeast or any yeast used in the production of wine or yeast such as Saccharomyces cerevisiae, Saccharomyces pastorianus, Brettanomyces bruxellensis, Brettanomyces anomalus, Brettanomyces custersianus, Brettanomyces naardenensis, Brettanomyces nanus, Dekkera bruxellensis, Dekkera anomala, Zygosaccharomyces and Brettanomyces, Saccharomyces boulardii, or any combination thereof.

In an exemplary embodiment, the ground edible plant tissue is modified ground edible plant tissue. The modified ground edible plant tissue is a ground edible plant tissue that has been modified. In some instances, being modified comprises being adapted, altered, changed, improved, revised, adjusted, customized, tailored, adapted, adjusted, changed, varied, transformed, revised or refashioned. In some instances, being modified comprises being physically modified or chemically modified. In some examples, being chemically modified comprises being chemically adapted, chemically altered, chemically changed, chemically improved, chemically revised, chemically adjusted, chemically customized, chemically tailored, chemically adapted, chemically adjusted, chemically changed, chemically varied, chemically transformed, chemically revised or chemically refashioned. In some examples, chemical modification is accomplished by any of the following procedures, or any combination of the following procedures: annealing, oxidation, oxidation, esterification, cros slinking, extrusion, pregelatinization or hydrolysis. In some embodiments, the modification of the ground edible plant tissue takes place while the tissue is intact edible plant, removed from the intact edible plant, prior to grinding the ground edible plant tissue, contemporaneous with grinding the ground edible plant tissue, subsequent to grinding the ground edible plant tissue, prior to incorporation of the ground edible plant tissue in the mixture or suspension, contemporaneous with the incorporation of the ground edible plant tissue into the mixture or suspension, after incorporation of the ground edible plant tissue into the mixture or suspension, prior to coating the mixture or suspension on the ingestible item, contemporaneous with coating the mixture or suspension on the ingestible item, after coating the mixture or suspension on the ingestible item, prior to cooking the coated ingestible item with the mixture or suspension, contemporaneous with cooking the coated ingestible item with the mixture or suspension, subsequent to cooking the coated ingestible item with the mixture or suspension, prior to packaging the cooked ingestible item, or contemporaneous with packaging the cooked ingestible item.

In some instances, the oxidation takes place at a pH of at least 4, 4.5, 5, 5.5, 6, 6.5, 7 or 7.5 and at most 5, 5.5, 6, 6.5, 7, 7.5 or 8. Sometimes, the oxidation reaction will comprise alkali hypochlorite, alkali chlorite, hydrogen peroxide, peracetic acid, alkali permanganate, or any combination thereof. In some embodiments, the alkali is an alkali ion comprising lithium (Li), sodium (Na), potassium (K), rubidium (Rb), cesium (Cs), francium (Fr) or any combination thereof. Sometimes, the alkali is an alkali earth ion comprising beryllium (Be), magnesium (Mg), calcium (Ca), strontium (Sr), barium (Ba), or radium (Ra). In some instances, the oxidation reaction will take place under controlled temperature. In some examples, the controlled temperature between temperatures of at least 4, 15, 20, 25, 30, 35, 40, 45, 50, or 80° C. and at most of at least 15, 20, 25, 30, 35, 40, 45, 50, 55, 60, 65, 70, 75, or 80° C.

In some embodiments, the esterification comprises succinic anhydride, 1-octenyl succinic anhydride, acetic anhydride, vinyl acetate, alkenyl substituted succinic anhydride, alkali tripolyphosphate, or any combination thereof. In some embodiments, the alkali is an alkali ion comprising lithium (Li), sodium (Na), potassium (K), rubidium (Rb), cesium (Cs), francium (Fr) or any combination thereof. Sometimes, the alkali is an alkali earth ion comprising beryllium (Be), magnesium (Mg), calcium (Ca), strontium (Sr), barium (Ba), or radium (Ra). Sometimes, the esterification reaction takes place at a pH of at least 4, 4.5, 5, 5.5, 6, 6.5, 7 or 7.5 and at most 5, 5.5, 6, 6.5, 7, 7.5 or 8, with subsequent pH adjustment of a pH of at least 5, 5.5, 6, 6.5, 7 or 7.5 and at most 5, 5.5, 6, 6.5, 7, 7.5 or 8. Occasionally, the esterification reaction takes place at a temperature of at least 15° C., 20° C., 25° C., 30° C., 35° C., 40° C., or 45° C. and at most of at least 15° C., 20° C., 25° C., 30° C., 35° C., 40° C., 45° C., or 50° C. In some instances, the etherification reaction comprises propylene oxide. In some embodiments, the esterification reaction using propylene oxide is performed at a pH of at least 8.5, 9.0, 9.5, 10.0, 10.5, 11.0, 11.5, 12.0, 12.5, 13.0, 13.5 or 14.0, and a pH of at most 9.0, 9.5, 10.0, 10.5, 11.0, 11.5, 12.0, 12.5, 13.0, 13.5 or 14.0. In some embodiments, the esterification reaction using propylene oxide is performed in a temperature of at least 15° C., 20° C., 25° C., 30° C., 35° C., 40° C., 45° C., or 50° C. and at most of at least 15° C., 20° C., 25° C., 30° C., 35° C., 40° C., 45° C., or 50° C. In some embodiments, the esterification reaction using propylene oxide is performed is followed a wash. Sometimes, the wash is performed in order to avoid gelatinization.

In some embodiments, the crosslinking utilizes a crosslinking reagent comprising phosphoryl chloride, adipic acetic mixed anhydride, sodium trimetaphosphate, mixtures of sodium trimetaphosphate, or mixture of tripolyphosphates. In some examples, the crosslinking reaction is performed at a pH of at least 8.5, 9.0, 9.5, 10.0, 10.5, 11.0, 11.5, 12.0, 12.5, 13.0, 13.5 or 14.0. Sometimes, the pre-gelatinization process takes place at a temperature of 15, 20, 25, 30, 35, 40, 45, 47, 50, 55, 57, 60, 65, 70, 75, 77, 80, 85, 90, 95, 100 or 105° C. In some instances, the crosslinking reaction is performed at a temperature of 25° C.

In some instances, the pregelatinization comprises spray cooking, drum frying, extrusion, or solvent based process. In some embodiments, the pregelatinization is performed by a method comprising spray cooking, drum frying, extrusion, solvent based process, or any combination thereof. Sometimes, the pre-gelatinization is starch pre gelatinization. In some instances, the pre gelatinization reaction takes place at a pH of at least 2, 3, 4, 4.5, 5, 5.5, 6, 6.5, 7, 7.5, 8 or 9 and at most 3, 4, 5, 5.5, 6, 6.5, 7, 7.5 8, 9 or 10. Sometimes, the pre-gelatinization process takes place at a temperature of 15, 20, 25, 30, 35, 40, 45, 50, 55, 60, 65, 70, 75, 80, 85, 90, 95, 100 or 105° C.

In some exemplary embodiments, the annealing comprises strengthening, toughening, galvanizing or forging. In some instances, the annealing is performed at a temperature of at least 90, 100, 110, 125, 150, 175, 200, 250, 300° C. to at most 110, 125, 150, 175, 200, 250, 300° C. In some instances, the annealing process lasts at least 1, 5, 10, 15, 20, 25, 30, 35, 40 or 45 minutes, and at most 40, 50, 60, 70, 80, 90, 100, 120 or 130 minutes.

In some embodiments, the hydrolysis is an acidic or basic hydrolysis. In some examples, the hydrolysis is an acidic hydrolysis. In some examples, the hydrolysis is a basic hydrolysis. Sometimes, the hydrolysis is an enzymatic hydrolysis. Sometimes the enzymatic hydrolysis comprises α-amylase, β-amylase glucoamylase, pullulunase, isoamylase, or any combination thereof. In some embodiments, the hydrolysis comprises several hydrolysis stages. In some examples the several hydrolysis stages comprise at least one stage selected from the group consisting of basic hydrolysis, acid hydrolysis and enzymatic hydrolysis.

In some examples, the extrusion is a hot extrusion, cold extrusion, warm extrusion, or any combination thereof. Sometimes the extrusion is direct extrusion, indirect extrusion, hydrostatic extrusion, or any combination thereof. In some instances, the extrusion is performed at a temperature of at least 90, 100, 110, 125, 150, 175, 200, 250, 300° C. to at most 90, 100, 110, 125, 150, 175, 200, 250, 300° C. In some instances, the extrusion is performed at a with a residence time of at least 1, 5, 10, 15, 20, 25, 30, 35, 40 or 45 seconds at most 40, 50, 60, 70, 80, 90, 100, 120 or 130 seconds. Sometimes, the extrusion comprises reactive extrusion, thermoplastic extrusion, enzyme catalyzed regioselective modification or any combination thereof. In some instances, the extrusion utilizes steam. In some instances the extrusion comprises pre-conditioning the digestible item.

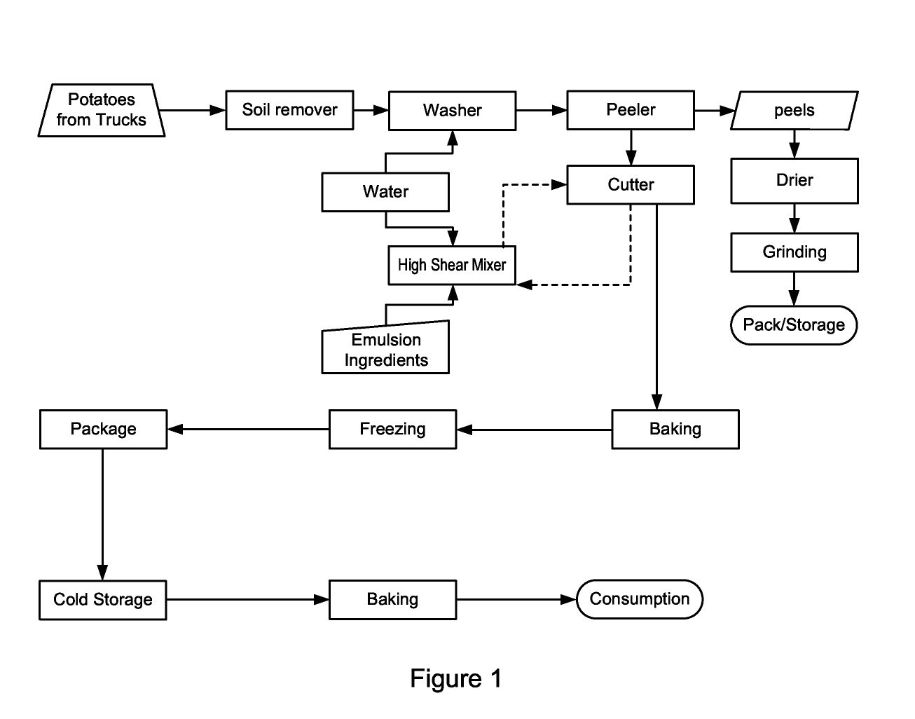

The invention further relates to a system or apparatus for the preparation of the coated ingestible item. An example for a system or apparatus is depicted in FIG. 1. In some examples the coated ingestible item having a desired texture is “french-fries” or “potato chips” type product.

In some instances, the invention comprises a peeling compartment, and a mixing compartment. In the peeling compartment, the edible plant tissues are separated from the intact edible plant. Sometimes, the separation is done by a peeler, a knife, a razor or a saw. The mixing compartment mixes the edible plant tissue part with fluid to form a mixture or suspension. In some instances, the mixture or suspension is an emulsion, cream or blend.

In some instances, the system or apparatus comprises a grinding compartment where the edible plant tissues are ground to the desired size. In some instances, the grinding that takes place in the grinding compartment comprises grinding, mincing, chopping, shredding, crumbling, cutting, hashing, or any combination thereof. Sometimes, the grinding takes place in the mixing compartment where the plant tissues are both ground and mixed either simultaneously or sequentially.

In some instances, the fluid added to the mixing compartment is an aqueous solution or water. In some embodiments, additives are added to the mixture, or suspension. Additives to the mixture comprise any additional ingredient that is added to the mixture as delineated above. Sometimes the mixture or suspension is an emulsion, cream or blend.

In some instances, the apparatus or system comprises a washer. Sometimes, the edible plant is washed in the washer. Occasionally, the ingestible item is washed in the washer. In some embodiments, the washer for the edible plant and the washer for the ingestible item is the same washer. In other instances, the washer for the edible plant is separate from the washer of the ingestible item.

Some embodiments comprise a soil remover compartment. In some embodiments soil, dirt, mud, dust, topsoil, clay or loam is removed from the edible plant in the soil remover compartment. In some exemplary embodiments, the ingestible item comprises a vegetable, a fruit, a meat or a pharmaceutical. In some instances, the soil remover removes soil, dirt, mud, dust, topsoil, clay or loam is removed from the ingestible item. In some embodiments, the soil remover for the edible plant and the soil remover for the ingestible item is the same soil remover. In other instances, the soil remover for the edible plant is separate from the soil remover of the ingestible item.

In some embodiments, the systems or apparatus comprises a receiver compartment. Sometimes, the receiver compartment is a reservoir, a tank, a box, a container, a storage device, a collection device, a stocking area, or a combination thereof. Occasionally, receiver compartment receives the edible plant. In other instances, the receiver compartment receives the ingestible item. In some embodiments, the receiver compartment for the edible plant and the receiver compartment for the ingestible item is the same receiver compartment. In other instances, the receiver compartment for the edible plant is separate from the receiver compartment of the ingestible item. Sometimes, the receiver compartment receives both edible plant and ingestible item simultaneously. In other instances, the receiver compartment receives both edible plant and ingestible item intermittently.

In some embodiments, the system or apparatus comprises a cutter. In the cutter, the ingestible item is processed. In some instances the item cut into predetermined pieces and thus it is processed. In some instances, the pieces are elongated, rectangular pieces. In other instances, the pieces are oval or round and have a small thickness of at least 0.01 inches, 0.05 inches, 0.1 inches, 0.2 inches, 0.3 inches, 0.4 inches, 0.5 inches, 0.6 inches, 0.7 inches, 0.8 inches, 0.9 inches, 1.0 inches, 1.1 inches, 1.2 inches, 1.3 inches, 1.4 inches, 1.5 inches, 1.6 inches, 1.7 inches, 1.8 inches, 1.9 or at least 2.0 inches. In other instances, the pieces are oval or round and have a small thickness of at most 0.01 inches, 0.05 inches, 0.1 inches, 0.2 inches, 0.3 inches, 0.4 inches, 0.5 inches, 0.6 inches, 0.7 inches, 0.8 inches, 0.9 inches, 1.0 inches, 1.1 inches, 1.2 inches, 1.3 inches, 1.4 inches, 1.5 inches, 1.6 inches, 1.7 inches, 1.8 inches, 1.9 or at most 2.0 inches.

In some embodiments, the apparatus or system further comprises a coating compartment where the processed item is coated with the mixture or suspension. In certain embodiments, coating the ingestible item is accomplished by spraying, dipping, smearing or immersing. Sometimes, coating is also be performed by using the mixture or suspension as an aerosol. In certain embodiments, the apparatus further comprises a compartment for removing access of coating from the coated ingestible item. In some examples, the removal of access is by shaking, vibrating, jarring, jolting, pulsating, juddering, shivering, shuddering, quaking, quivering, trembling, rocking, bumping, wobbling, rattling, quivering or agitating.

In some examples, the apparatus or system further comprises a cooking compartment where the finally covered ingestible item is cooked. In some embodiments, cooking is performed using a certain cooking method. Sometimes, the cooking method comprises baking, frying, microwaving, freezing, de-humidifying, lyophilizing, slow-cooking, boiling, broiling, grilling, steaming, steam cooking, or any combination thereof.

In some examples, the system or apparatus comprises more than one baking compartments. In some embodiments, the systems or apparatus comprises more than one compartment from each compartment type which was delineated above.

In some embodiments, the system or apparatus comprises a packaging compartment. In the packaging compartment, the ingestible item having a cooked coating is packaged. Sometimes, packaging comprises wrapping, packing, boxing, covering, casing, binding, parceling, bundling, embalming, enveloping, or any combination thereof. In some embodiments, the packaging comprises addition of air or gas. In some examples, the packaging comprises removal or air or gas.

In some embodiments, the apparatus or system further comprises storage compartment of the ingestible item having a cooked coating. Sometimes, the storage compartment comprises the ingestible item having a cooked coating before packaging. Sometimes, the storage compartment comprises the ingestible item having a cooked coating after packaging. Sometimes, the storage compartment is a reservoir, a tank, a box, a container, a storage device, a collection device, a stocking area, or a combination thereof. In some embodiments, the storage comprises storage in ambient temperatures, elevated temperatures or cold temperatures.

In some exemplary embodiments, storage is performed at least at −50° C., −20° C., −10° C., 0° C., 10° C., 20° C., 30° C., 40° C., 50° C., 60° C., 70° C., 80° C., 90° C., 100° C., 120° C., 130° C., 140° F. or at least 150° C. In some embodiments, storage is performed at most at −30° C., −20° C., −10° C., 0° C., 10° C., 20° C., 30° C., 40° C., 50° C., 60° C., 70° C., 80° C., 90° C., 100° C., 120° C., 130° C., 140° C. or at most 150° F.

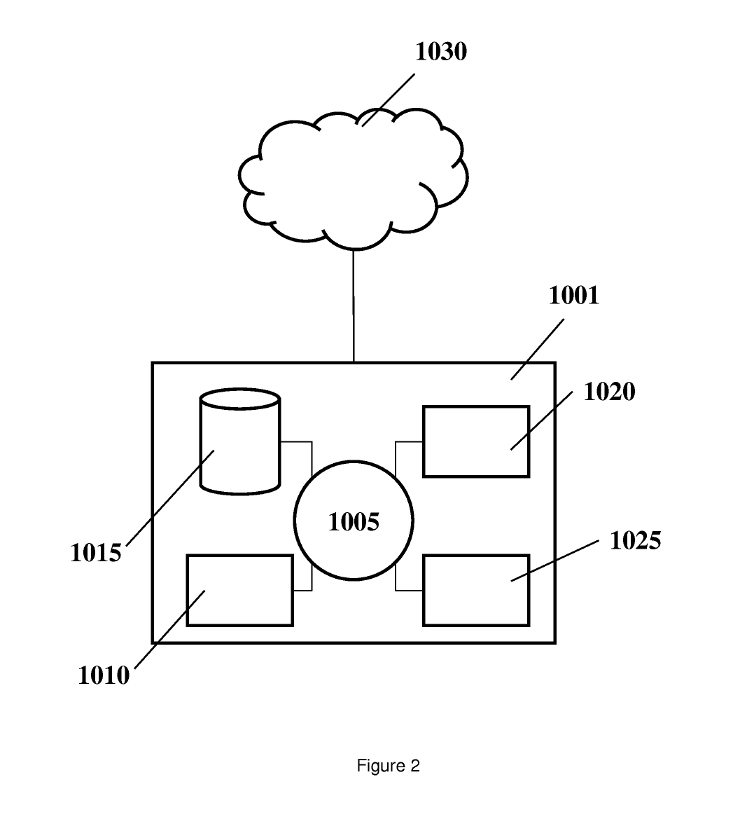

The invention further relates to a computer system controlling the system or apparatus for the preparation of the coated ingestible item. An example for a computer system is depicted in FIG. 2.

The present disclosure provides computer control systems that are programmed to implement methods of the disclosure. FIG. 2 shows a computer system 1001 that is programmed or otherwise configured to control system or apparatus for the preparation of the coated ingestible item. In some examples, the computer system 1001 regulates various aspects of the timing, rate and sequence at which the various abovementioned components operate. In some examples, the computer controls the cutting speed of the cutters in the cutting compartment. In other embodiments, the computer controls the destination size to which the edible plant tissue is cut. In some examples, the computer controls the speed at which the peeler peels the edible plants. In some examples, the computer controls the type of tissue or tissues that are peeled. In some examples, the computer controls the content of the fluid that is inserted to the mixture for the preparation of the mixture or suspension. In some embodiments, the computer controls the type and amounts of the additional items added to the mixture or suspension. In some examples, the computer controls the timing, amount, and temperature of cooking. In some instances, where more than one cooking steps is incorporated, the computer controls the sequence of cooking steps. In some examples, the computer controls the type of packaging used. Occasionally, the computer controls the type of design placed on the packaging. The computer system 1001 includes a central processing unit (CPU, also “processor” and “computer processor” herein) 1005. In some examples, the CPU comprises a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1025 are in communication with the CPU 1005 through a communication bus (solid lines), such as a motherboard. Sometimes, the storage unit 1015 is a data storage unit (or data repository) for storing data. Sometimes, the computer system 1001 is operatively coupled to a computer network (“network”) 1030 with the aid of the communication interface 1020. Sometimes, the network 1030 is the Internet, an internet and/or extranet, or an intranet and/or extranet that is in communication with the Internet. The network 1030 in some cases is a telecommunication and/or data network. Sometimes, the network 1030 includes one or more computer servers. In some instances, the servers enable distributed computing, such as cloud computing. In some cases, the network 1030, with the aid of the computer system 1001, implements a peer-to-peer network, which in some instances enables devices coupled to the computer system 1001 to behave as a client or a server.

In some instances, the CPU 1005 executes a sequence of machine-readable instructions. Sometimes, the machine readable instructions are embodied in a program or software. In some instances, the instructions are stored in a memory location, such as the memory 1010. Examples of operations performed by the CPU 1005 include fetch, decode, execute, and writeback.

In some instances, the storage unit 1015 is able to store files, such as drivers, libraries and saved programs. Sometimes, the storage unit 1015 stores user data, e.g., user preferences and user programs. Sometimes, the computer system 1001 includes one or more additional data storage units that are external to the computer system 1001, such as located on a remote server that is in communication with the computer system 1001 through an intranet or the Internet.

In some embodiments, the computer system 1001 communicates with one or more remote computer systems through the network 1030. In some embodiments, the computer system 1001 communicates with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. In some examples, the user accesses the computer system 1001 via the network 1030.

In some embodiments, methods as described herein are implemented by way of machine (e.g., computer processor) executable code stored on an electronic storage location of the computer system 1001, such as, for example, on the memory 1010 or electronic storage unit 1015. In some instances, the machine executable or machine readable code is provided in the form of software. In some embodiments, the code is executed by the processor 1005. In some cases, the code is retrieved from the storage unit 1015 and stored on the memory 1010 for ready access by the processor 1005. In some situations, the electronic storage unit 1015 is precluded, and machine-executable instructions are stored on memory 1010.

In some embodiments, the code is pre-compiled and configured for use with a machine have a processer adapted to execute the code, or can be compiled during runtime. Sometimes, the code is supplied in a programming language that is selected to enable the code to execute in a pre-compiled or as-compiled fashion.

In some embodiments, aspects of the systems and methods provided herein, such as the computer system 1001, are embodied in programming. In some instances, various aspects of the technology are thought of as “products” or “articles of manufacture” typically in the form of machine (or processor) executable code and/or associated data that is carried on or embodied in a type of machine readable medium. In some embodiments, machine-executable code is stored on an electronic storage unit, such memory (e.g., read-only memory, random-access memory, flash memory) or a hard disk. In some instances, “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. In some examples, such communications enable loading of the software from one computer or processor into another, for example, from a management server or host computer into the computer platform of an application server. Thus, another type of media that bears the software elements includes in some examples optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some embodiments, the computer system 1001 includes or be in communication with an electronic display that comprises a user interface (UI) for providing, for example, various aspects of systems or apparatus for the preparation of the coated ingestible item. Examples for aspects are the size of ground edible plant tissue, the operative status of each compartment, the amount of ingredients in each compartment, and the stage at which the ingestible item is in each compartment. In some embodiments, the ingredient is the edible item, ingestible item, fluid, or any component of the mixture or suspension. In some instances, the display includes the present or historical level of any ingredient, or both present and historical levels. In some embodiments, these levels are displayed with the corresponding name or image of the various compartments of the apparatus or system for the preparation of the coated ingestible item. Sometimes, the level displayed is a real time level or at a historical level. Sometimes, the display of the aforementioned operational status includes present state operational status or past (historical) operational status. Any of the abovementioned historical (past) levels, as well as the corresponding historical date and time in which the levels were collected, are in some instances saved in any of the abovementioned storage systems or their combination. Sometimes, the saved levels are accessed by the computer system and/or by a user. In some instances, saving is effectuated by the computer system, by a user, or by both. Sometimes, the historical data is accessible by the computer system, by a user, or by both. Sometimes, the historical levels displayed is of a past date and/or time chosen by the user, or of a predetermined date and/or time. In some examples, the display also comprises a sketch of all the components of the system or apparatus for the preparation of the coated ingestible item. Sometimes, the sketch displays the current operational status of the particular compartments. Sometimes, the sketch also displays the abovementioned real time levels, historical levels, or both. In some embodiments, the display further includes a user interface. Sometimes, the user interface allows manual control of any of the components of the system or apparatus for the preparation of the coated ingestible item. In some embodiments, such user control is effectuated by the user using a touch screen, a remote control device, computer “mouse,” keypad, keyboard, touchpad, stylus, joystick, thumb wheel, voice recognition interface, any other user input interface known in the art, or a combination thereof. Examples of UP s include, without limitation, a graphical user interface (GUI) and web-based user interface.

In some instances, the methods and systems of the present disclosure are implemented by way of one or more algorithms. Sometimes, the algorithm is implemented by way of software upon execution by one or more computer processors.

The following example is illustrative of one or more embodiments of the present disclosure and is thus non-limiting.

Example 1: a process for making crispy potato ‘french-fry type” without the addition of oil, fats, shortenings, substitutes, or any combinations thereof. This process is also suitable to produce crunchy, brittle, fracturable, fragile, breakable, frail, breakable, delicate, easily-broken, dry or non-soggy potato ‘french-fry type.” The procedure included the following steps: Emulsion: 0.8% weight by weight (wt/wt) modified cellulose were combined with 1.4% wt/wt of powdered potato skin, periderm, cortex, or combination thereof; and further were combined with 0.1% wt/wt lecithin; and further were combined with 0.1% wt/wt table salt; and further were combined with 97.6% wt/wt water in an in-line or batch mixing in an agitated tank. The weight by weight percentage is measured against the entire emulsion weight. The aforementioned emulsion ingredients were homogenized to prepare a stable emulsion or suspension. Potato Preparation: Russet potatoes were washed, peeled and cut into elongated strips (as for “French fry” type potatoes). Coating: The mixture or suspension was enrobed on the elongated potato strips. Excess of coating was removed with an air gun. The final ratio coating to potato was 1:100 respectively. The coated potato strips were baked at 190° C. for 18 minutes. The baked coated potato strips were packaged, frozen and stored at −20° C. for one week. The frozen baked coated potato strips were either baked at 190° C. for five minutes or microwaved on “High” microwave level for 20 seconds, such that they were heated to the temperature suitable for human or animal consumption. The resulting heated baked coated potato strips had a crispy cover with a soft center.

Example 2: A process for making crispy potato chips without the addition of oil, fats, shortenings, substitutes, or any combinations thereof. Such process is also suitable to produce crunchy, brittle, fragile, breakable, frail, breakable, delicate, easily-broken, dry or non-soggy potato chips. Emulsion: 0.6% wt/wt modified cellulose was combined with 4.2% wt/wt powdered potato skin, periderm, cortex or any combination thereof; and further combined with 1.0% wt/wt table salt, and further combined with 0.1% wt/wt sodium alginate, and further combined with 0.1% wt/wt stearic acid, and further combined with 97.4% wt/wt water. The weight by weight percentage is measured against the entire emulsion weight. The combined aforementioned materials were mixed in an agitated tank to form a mixture. The mixture was homogenized to form a stable emulsion or suspension. Potato Preparation: Russet potatoes were washed, peeled and sliced to a thickness of 1.5 mm elongated slices (i.e. “French fries” type in shape). Coating: The cut elongated potato pieces were enrobed with the mixture or suspension. Excess coating was removed with an air gun. The final ratio of coating to potato obtained was 1:200 respectively. The cut and coated potato strips were baked at 350° C. for 20 minutes until crispy. The baked coated potato strips were cooled to room temperature or ambient temperature. The cooled, baked coated potato strips were packaged and stored for one week.

Example 3: a process for making crispy potato ‘french-fry type” with less than 1% of caloric value provided by addition of oil, fats, shortenings, substitutes, and or combinations thereof. Emulsion: 0.46% wt/wt modified cellulose were combined with 1.07% wt/wt powdered potato skin or periderm and or cortex, and further combined with 0.08% wt/wt lecithin, and further combined with 4.0% wt/wt table salt, and further combined with 0.07% wt/wt Sodium Alginate, and further combined with 0.09% wt/wt Stearic acid, and further combined with 1.58% wt/wt Canola Oil, and further combined with 0.01% wt/wt Oregano oil, and further combined with 0.02% wt/wt Amino-acids blend, and further combined with 0.72% wt/wt Spices blend, and further combined with 91.9% wt/wt water. The weight by weight percentage is measured against the entire emulsion weight. The aforementioned combined ingredients were mixed in an agitated tank to form a mixture. The mixture was homogenized to form a stable emulsion or suspension which constituted the coating. Potato Preparation: Golden Yukon potatoes were washed, peeled and cut into round, oval or “potato chip” shape of about ¼ inch thick slices. Coating: the potato pieces were enrobed with the coating. Excess coating was removed with an air gun. The final ratio coating to potato was 1:100 respectively. The cut and coated potato strips were baked at 176° C. for 20 minutes until crispy. The baked coated potato strips were cooled to room temperature or ambient temperature. The cooled, baked coated potato strips were packaged and stored for one week.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein can be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

Example 4: Russet Burbank potatoes were thoroughly cleaned and washed, then sliced at a 1/16 inch thickness and then thoroughly washed until water was completely clear. Excess water was removed from the potato slices which were then immersed into solutions containing asperiginase enzyme at 18° C. at 20 and 1000 ppm concentrations. 2,000 grams of slices were immersed in the 20 ppm solution for 5 minutes; then the solution was drained and potatoes stood for additional 10 minutes before the excess solution was removed from the potato by using a centrifuge unit at 600 rpm. In the second group, 2,000 grams of potato slices were immersed in the 1,000 ppm solution for 5 minutes, then the solution was drained and the potatoes remained coated for 5 minutes before the excess solution was removed from the potatoes by using a centrifuge unit at 600 rpm. The potatoes were then cooked in a convection oven at 190° C. for 9 minutes and then cooled off. The final product was a whitish crispy crunchy potato slice.

Example 5: Bridget potatoes were thoroughly cleaned and washed, then sliced at a thickness between ⅛ inch and 1/32 inch then thoroughly washed until water was completely clear. Excess water was removed from the potato slices which were then immersed into a 5% vinegar solution at 18° C. for 1 hour. Potatoes slices softened in texture with a smoother surface. The excess vinegar solution was then removed from the potatoes by using a centrifuge unit at 600 rpm. The potatoes were then cooked in a convection oven at 190° C. for 9 minutes (for the 1/32 inch slices) and 11 minutes (for the ⅛ inch slices), then cooled off. The final products were very light yellow crispy crunchy potato slices.

Example 6: Russet potatoes were thoroughly cleaned and washed, then sliced at a 1/16 inch thickness and thoroughly washed until water was completely clear. Excess water was removed from the potato slices which were then immersed into solutions containing lipase enzyme at 18° C. at 10 and 500 ppm concentrations. 2,000 grams of slices were immersed in the 10 ppm solution for 10 minutes; then the solution was drained and potatoes stood for additional 10 minutes before the excess solution was removed from the potato by using a centrifuge unit at 600 rpm. In the second group, 2,000 grams of potato slices were immersed in the 500 ppm solution for 5 minutes, then the solution was drained and the potatoes remained coated for 5 minutes before the excess solution was removed from the potatoes by using a centrifuge unit at 600 rpm. The potatoes were then cooked in a convection oven at 190° C. for 10 minutes and then cooled off. The final product was a whitish crispy crunchy potato slice.

Example 7: 2,000 grams of Russet Burbank potatoes were thoroughly cleaned and washed, then sliced at a 1/16 inch thickness and thoroughly washed until water was completely clear. Excess water was removed from the potato slices which were then immersed into solutions containing 300 ppm of asperiginase enzyme, 1% sea salt, 0.5% spices (in 7:2:1 weight ratios of powdered habanero peppers, cumin, and powdered tarragon respectively) at 18° C. for 25 minutes. Then the solution was drained and potatoes stood for additional 5 minutes before the excess solution was removed from the potato by using a centrifuge unit at 600 rpm. The slices were then immersed for 1 minute in an emulsion containing 0.8% weight by weight (wt/wt) modified cellulose, 1.4% wt/wt of powdered potato skin, periderm, cortex, or combination thereof; 0.1% wt/wt lecithin; 97.7% wt/wt water. The weight by weight percentage is measured against the entire emulsion weight. The aforementioned emulsion ingredients were homogenized to prepare a stable emulsion or suspension. The excess coating solution was removed from the potatoes by using an air gun. The potatoes were then cooked in a convection oven at 190° C. for 9 minutes and then cooled off. The final product was a whitish crispy crunchy potato slice in which flavors were trapped or encapsulated by the coating and slowly released upon chewing.

Example 8: Thin trimmed lean slices of round beef cut (⅛ inch thick) were immersed in a solution containing 50% organic vinegar (conc. 5%), 0.5% liquid smoke flavor, and 49.5% filtered marinade solution for 2 hours at 3° C. The filtered marinade solution was made by (a) mixing 85% water, 5% table salt, 3% brown sugar, 2% capers, 1% fresh garlic, 1% fresh basil, 1% fresh tarragon, 1% cumin, 0.5% mustard seeds, and 0.5% powdered habanero peppers in a weight by weight basis, (b) cooking the mixture and let it boil for 3 minutes (c) filtering the solution and dispose off the solids (d) cool off filtered marinade solution to 3° C. The slices were then immersed for 30 seconds in an emulsion containing 1.2% weight by weight (wt/wt) modified cellulose, 1.8% wt/wt of powdered potato skin, periderm, cortex, or combination thereof; 0.01% wt/wt Stearic acid, 0.01% wt/wt sodium alginate; 96.98% wt/wt water. The weight by weight percentage is measured against the entire emulsion weight. The aforementioned emulsion ingredients were homogenized to prepare a stable emulsion or suspension. The excess coating solution was removed from the meat slices by using an air gun. The potatoes were then cooked in a convection oven at 121° C. until meat temperature reached 79° C. and then at 51° C. until meat was dry. The final product was a dry smoked jerky meat type in which flavors and aromas were trapped or encapsulated by the coating and slowly released upon chewing.

Example 9: Skinless chicken drumsticks were immersed in a solution containing a mixture of 80% water; 4% Vinegar (5% conc.); 4% table salt; 2% capers; 1.8% wt/wt of powdered potato skin, periderm, cortex, or combination thereof; 1.8% wt/wt powdered potato; 1.2% weight by weight (wt/wt) modified cellulose; 1% fresh garlic, 1% fresh basil, 1% fresh tarragon, 1% cumin, 0.5% mustard seeds, and 0.5% powdered habanero peppers, 0.01% wt/wt stearic acid, 0.01% wt/wt sodium alginate during 4 hours. The weight by weight percentage is measured against the entire emulsion weight. The aforementioned emulsion ingredients were homogenized to prepare a stable emulsion or suspension. The drumsticks were then cooked in a convection oven at 204° C. until meat temperature reached 55° C. and subsequently frozen. Two weeks later, the chicken drumsticks were baked in a convection oven at 204° C. for 12 minutes and the final product was a crispy crunchy chicken in which flavors and aromas were trapped or encapsulated into the moist flesh by the coating and slowly released upon chewing.

Exampe 10. 100 grams of a powder dry mix containing 50% wt/wt ascorbic acid (vitamin C) and 50% wt/wt vitamin E was prepared by mixing. 50 grams of an emulsion comprising 0.6% wt/wt modified cellulose, 4.2% wt/wt powdered potato skin, periderm, cortex or any combination thereof; 0.1% wt/wt sodium alginate, 0.1% wt/wt stearic acid, and further combined with 95% wt/wt water. The weight by weight percentage is measured against the entire emulsion weight. The combined aforementioned materials in the emulsion were mixed to form a homogeneous mixture. The mixture was homogenized to form a stable emulsion or suspension. The emulsion was added to the vitamin dry mix and baked at 4° C. until the moisture content was reduce to 1%. The final product was a white powder of which flavor was release upon chewing or breaking up the particles. The coated particles showed stability when drizzled over wet edible surface products without release of the vitamins.

What is claimed is:

1. A method for coating an ingestible item comprising:
a) grinding plant tissue to generate ground edible plant parts wherein said ground edible plant tissue parts comprises at least one cell and at most one hundred cells;
b) preparing a mixture comprising said ground edible plant tissue and coating an ingestible item with said mixture, wherein said mixture has a viscosity of at least 0.01 centipoises;
c) baking said ingestible item wherein an external texture is imparted that remains essentially intact for at least two hours.

2. The method of claim 1, wherein said external texture imparts a crispy, crunchy, crusty, brittle, not-soggy, not-soft, crumbly or hard mouth-feel,
has a peak force of at least 10 Newtons per gram,
has a moisture content of at most 35 weight by weight percent of water,
has an ultrasonic velocity of at least 100 minutes per second, and
has a transmission loss of at least 0.20 dB/mm.

3. The method of claim 1, wherein said ingestible item comprises a vegetable, a fruit, a meat, a nut, a seed, or a pharmaceutical.

4. The method of claim 1, wherein said ground edible plant tissue parts comprises particles of at least 0.001 micrometers and at most 5,000 micrometers in size, and comprises at most 0.01 weight by weight percent of said mixture coating.

5. The method of claim 1, wherein said mixture comprises cellulose, hemicellulose, modified cellulose or modified hemicellulose.

6. The method of claim 1, wherein said mixture comprises a binding agent.

7. The method of claim 1, wherein said mixture comprises an emulsifier.

8. A processed ingestible plant section that is coated by a mixture comprising
a) at least one component derived from a ground plant tissue of multiple plants, wherein a size of plant tissue is at least one cell and at most one hundred cells; and
b) at least one component that either mimics or comprises an external plant tissue, wherein a weight by weight percentage of plant section is at most 99 percent and a weight by weight percentage of said mixture is at least 0.01 percent of said plant section.

9. The processed plant of claim 8, wherein said mixture or suspension has a viscosity of at least 0.01 centipoises.

10. The processed plant of claim 8, wherein said coating mixture imparts a crispy, crunchy, crusty, brittle, not-soggy, not-soft, crumbly or hard mouth-feel,
has a peak force of at least 10 Newtons per gram,
has a moisture content of at most 35 weight by weight percent of water,
has an ultrasonic velocity of at least 100 minutes per second, and
has a transmission loss of at least 0.20 dB/mm.

11. The processed plant of claim 8, wherein said ingestible item comprises a vegetable, a fruit, a meat, or a pharmaceutical.

12. The processed plant of claim 8, wherein said ground edible plant tissue parts comprises particles of at least 0.001 micrometers and at most 5,000 micrometers in size, and comprises at most 0.5 weight by weight percent of said mixture coating.

13. The processed plant of claim 8, wherein said mixture comprises cellulose, hemicellulose, modified cellulose or modified hemicellulose.

14. The processed plant of claim 8, wherein said mixture comprises a binding agent.

15. The processed plant of claim 8, wherein said mixture comprises an emulsifier.

16. The processed plant of claim 8, wherein said oil content is less than 1.6% weight by weight.

17. A method for distributing an ingestible item having a desired texture, comprising the steps of:
a) grinding plant tissue wherein a size of plant tissue is at least one cell and at most one hundred cells;
b) preparing a mixture of ground plant tissue and coating an ingestible item with said mixture, wherein said mixture has a viscosity of at least 0.01 centipoises;
c) baking said ingestible item wherein an external texture is imparted that remains essentially intact for at least two hours;
d) providing said ingestible item in exchange for a fee.

18. A method for coating an ingestible item comprising:
a) subjecting the surface of the ingestible item to undergo a chemical reaction with an active agent for at least one second and at most 48 hours,
b) baking said ingestible item wherein an external texture is imparted that remains essentially intact for at least two hours.

19. A method for encapsulation an ingestible item comprising:
a) subjecting the surface of the ingestible item to undergo a chemical reaction with an active agent for at least one second and at most 48 hours,
b) coating the ingestible item with a mixture of ground plant tissue, wherein a size of plant tissue is at least one cell and at most one hundred cells, and
c) baking said ingestible item wherein an external texture is imparted that remains essentially intact for at least two hours.
